(19) United States
(12) Patent Application Publication
(10) Pub. No.: US 2025/0086668 A1
(43) Pub. Date: Mar. 13, 2025

(54) METHOD FOR DETERMINING PAYOUT RATE OF SECONDARY STAKABLE TOKENS BY REFERRING TO STAKING INFORMATION ON PRIMARY STAKABLE TOKENS OF SPECIFIC USER AND STAKING MANAGEMENT SERVER USING THE SAME

(71) Applicant: Wemade Co., Ltd., Seongnam-si (KR)

(72) Inventor: Moheon SONG, Seoul (KR)

(21) Appl. No.: 18/405,708

(22) Filed: Jan. 5, 2024

(30) Foreign Application Priority Data
Sep. 7, 2023 (KR) 10-2023-0119299

(51) Int. Cl. G06Q 30/0207; G06Q 20/36; G06Q 20/38

(52) U.S. Cl. CPC G06Q 30/0212; G06Q 20/367; G06Q 20/3825; G06Q 20/3827; G06Q 20/3829; G06Q 2220/00

(57) ABSTRACT

Method for determining a payout rate of secondary stakable tokens according to staking information on primary stakable tokens is provided. The method includes steps of: a staking management server determining, a ratio of a cumulative issuance volume of the secondary stakable tokens to a total staked quantity of the primary stakable tokens, as a first stake-related partial index whenever a transaction occurs, and a first specific user stake-related index according to the first stake-related partial index stored when the transaction is generated by a specific user, updating a current first total stake-related index according to a last value of the first stake-related partial index corresponding to a most recent transaction, wherein, in response to a reward request transaction, a specific user reward token quantity is determined according to a specific staked quantity and a difference between the current first total stake-related index and a previous first specific user stake-related index.

### CROSS REFERENCE OF RELATED APPLICATION

This present application claims the benefit of the earlier filing date of Korean non-provisional patent application No. KR 10-2023-0119299, filed on Sep. 7, 2023, the entire contents of which being incorporated herein by reference.

### FIELD OF THE DISCLOSURE

The present disclosure relates to a method for determining a payout rate of secondary stakable tokens by referring to staking information on primary stakable tokens of a specific user and a staking management server using the same; and more particularly, to the method of determining unit point for calculating additional payouts according to a staked period of the primary stakable tokens of the specific user and assigning the unit point to the specific user and the staking management server using the same.

### BACKGROUND OF THE DISCLOSURE

Proof-of-Stake refers to a method of distributing newly issued tokens probabilistically according to each amount of tokens held by each participant in a staking pool, instead of determining how to distribute the newly issued tokens by referring to each mining amount like existing Bitcoins do.

The term ‘staking’ in the field of blockchain comes from the idea that tying up tokens is like driving a stake into the ground. In order for Proof-of-Stake to work, holders of the tokens must be rewarded for holding the tokens for a long period of time, since this will encourage people to hold the tokens, leading to a rise in a value of the tokens. To accomplish this, the tokens that are being staked are compelled to be held for a long term by making them illiquid, i.e., by staking and immobilizing them. In other words, those who participate in staking receive some sort of interest in exchange for freezing their tokens.

However, almost all of staking systems so far have not made efforts to implement a configuration that awards additional points (which is differentiated from a conventional points provided to a user) according to how long the user has been staking the tokens.

Therefore, it is necessary to develop a method for determining additional rewards to be provided to a specific user by assigning each unit point for calculating additional payouts to each block, each unit point for the each block being determined according to a staked period of the specific user's primary stakable tokens.

Therefore, an enhanced method for solving the aforementioned problems is required.

### SUMMARY OF THE DISCLOSURE

It is an object of the present disclosure to solve all the aforementioned problems.

It is another object of the present disclosure to allow users to concentrate on staking of primary stakable tokens during an earlier period of time so that a quantity of secondary stakable tokens provided as reward tokens to the users for taking the primary stakable tokens increases according to a staking duration thereof, thereby reducing a waste of hardware required for mining tokens.

It is still another object of the present disclosure to prevent delays in computing stake-related indexes necessary for distributing the reward tokens according to a token reward request transaction and reduce a burden on the hardware required for computation thereof by updating a total stake-related index and a specific stake-related index of a specific user when the specific user generates a transaction.

It is still yet another object of the present disclosure to determine a first reward basis value, generated by referring to a specific staked quantity of the primary stakable tokens corresponding to the specific user and a difference between a current first total stake-related index and a previous first specific user stake-related index of the specific user, as a specific user reward token quantity corresponding to the specific user.

It is still yet another object of the present disclosure to accumulate a unit point for calculating additional payouts at each block according to each staked period of a 1-st user to a z-th user, generate a second reward basis value by referring to the unit point for calculating additional payouts and the first reward basis value, and determine a specific user secondary stakable token quantity corresponding to the specific user by referring to the second reward basis value.

In order to achieve the objectives of the present disclosure as described above, and to realize characteristic effects of the present disclosure as described below, characteristic configurations of the present disclosure are as follows.

In accordance with one aspect of the present disclosure, there is provided a method for determining a payout rate of secondary stakable tokens by referring to staking information on primary stakable tokens of a specific user, including steps of: (a) determining, by a staking management server, as a first stake-related partial index, a first ratio of a cumulative issuance volume of the secondary stakable tokens, acquired from an issuance volume of the secondary stakable tokens per block, to a total staked quantity of the primary stakable tokens acquired by summing up each of the staked quantities of the primary stakable tokens of each of all users who have staked the primary stakable tokens in a specific staking pool, wherein the first stake-related partial index has its corresponding value calculated and stored whenever a specific transaction, selected among a token staking transaction, a token unstaking transaction and a token reward request transaction, occurs by any user among all the users participating in the specific staking pool; and (b) performing, by the staking management server, a process of determining a first specific user stake-related index by referring to a specific value of the first stake-related partial index, stored as a result of the specific transaction being generated by the specific user among all the users, and a process of updating a current first total stake-related index by referring to a last value of the first stake-related partial index, stored as a result of generating, as a most recent transaction, any one of the token staking transaction, the token unstaking transaction and the token reward request transaction, wherein, at the step of (b), in response to the most recent transaction being determined as the token reward request transaction generated as the specific transaction by the specific user at a specific block, the staking management server (i) updates the current first total stake-related index by referring to the last value of the first stake-related partial index, stored as a result of generating the token reward request transaction as the most recent transaction, (ii) determines a first reward basis value as a specific user reward token quantity corresponding to the specific user, wherein the first reward basis value is generated by referring to a specific staked quantity of the primary stakable tokens corresponding to the specific user and a difference between the current first total stake-related index and a previous first specific user stake-related index of the specific user stored prior to updating to the first specific user stake-related index according to the last value of the first stake-related partial index stored as a result of generating the token reward request transaction as the specific transaction, and (iii) updates the previous first specific user stake-related index to the first specific user stake-related index by referring to the last value of the first stake-related partial index stored as a result of generating the token reward request transaction as the specific transaction.

As one example, wherein, at the step of (b), in response to the token reward request transaction being generated at a (k_n)-th block, which is the specific block, the staking management server (i) acquires the current first total stake-related index by summing up each value of the first stake-related partial index calculated from each of a (k_1)-st block to the (k_n)-th block at which any of the token staking transaction, the token unstaking transaction and the token reward request transaction has occurred, among a first block to a p-th block generated up to a current point of time, and (ii) acquires the previous first specific user stake-related index by summing each value of the first stake-related partial index calculated from each of the (k_1)-st block to a (k_m)-th block as a result of generating any one of the token staking transaction, the token unstaking transaction and the token reward request transaction at the (k_m)-th block, which is a block previous to the (k_n)-th block, by the specific user who requested the token reward request transaction.

As another example, wherein, at the step of (b), the staking management server accumulates a unit point for calculating additional payouts at each block according to each staked period of a 1-st user to a z-th user, generates a second reward basis value by referring to the unit point for calculating additional payouts and the first reward basis value, and determines a specific user secondary stakable token quantity corresponding to the specific user by referring to the second reward basis value, wherein, in response to a first reward-requesting user, among the 1-st user to the z-th user, having staked the primary stakable tokens by a certain number of blocks later than a second reward-requesting user, the staking management server assigns a penalty of a predetermined penalty condition to a first secondary stakable token quantity of the first reward-requesting user, and determines the second reward basis value by assigning a reward of a predetermined reward condition corresponding to the penalty to a second secondary stakable token quantity of the second reward-requesting user.

As another example, wherein, starting from an (L_2)-nd block succeeding an (L_1)-st block in which the specific user corresponding to any one of the 1-st user to the z-th user has begun staking the primary stakable tokens, the staking management server accumulates, as the unit point for calculating additional payouts at each block, a ratio of a cumulative number of blocks, corresponding to a staked period starting from the (L_2)-nd block, to a total number of blocks generated within a specific period of time in which the unit point for calculating additional payouts is accumulatively calculated.

As another example, wherein the staking management server (i) determines, as a unit point for calculating additional payouts of the specific user, the unit point for calculating additional payouts accumulated for the specific user at an (L_i)-th block generated by a specific number of blocks later than an (L_2)-nd block, succeeding an (L_1)-st block in which the specific user corresponding to any one of the 1-st user to the z-th user has begun staking the primary stakable tokens, and (ii) determines, as a unit point for calculating additional payouts of all the users, a sum of the unit point for calculating additional payouts accumulated for each of all the users at the (L_i)-th block, and wherein, in response to the token reward request transaction being generated at a (k_n)-th block, which is the specific block, the staking management server (i) (i−1) for each of a (k_1)-st block to the (k_n)-th block, at which any of the token staking transaction, the token unstaking transaction and the token reward request transaction has occurred, among a first block to a p-th block generated up to a current point of time, sets a (2_1)-st ratio to a (2_n)-th ratio of the cumulative issuance volume of the secondary stakable tokens to each of sums of each of total staked quantities of the primary stakable tokens corresponding to each of the (k_1)-st block to the (k_n)-th block and each unit point for calculating additional payouts of all the users corresponding to each of the (k_1)-st block to the (k_n)-th block, as a (2_1)-st stake-related partial index to a (2_n)-th stake-related partial index, and acquires a current second total stake-related index by summing up each of the (2_1)-st stake-related partial index to the (2_n)-th stake-related partial index, and (i−2) as a result of generating any one of the token staking transaction, the token unstaking transaction and the token reward request transaction at a (k_m)-th block, which is a block previous to the (k_n)-th block, by the specific user who requested the token reward request transaction, sets, at each of the (k_1)-st block to the (k_m)-th block, a (3_1)-st ratio to a (3_m)-th ratio of the cumulative issuance volume of the secondary stakable tokens to each of sums of each of total staked quantities of the primary stakable tokens corresponding to each of the (k_1)-st block to the (k_m)-th block and each unit point for calculating additional payouts of all the users corresponding to each of the (k_1)-st block to the (k_m)-th block, as a (3_1)-st stake-related partial index to a (3_m)-th stake-related partial index, and acquires a second specific user stake-related index by summing up each of the (3_1)-st stake-related partial index to the (3_m)-th stake-related partial index, and (ii) generates the second reward basis value by referring to the specific staked quantity of the primary stakable tokens corresponding to the specific user, the unit point for calculating additional payouts of the specific user, and a difference between the current second total stake-related index and the second specific user stake-related index, and determines specific user secondary stakable token quantity corresponding to the specific user by referring to the second reward basis value.

As another example, wherein, at the step of (b), when the specific transaction, which is the token reward request transaction generated by the specific user, occurs at a same block as another transaction, which is any one of the token staking transaction and the token unstaking transaction generated by another user, the specific transaction is performed first and then the another transaction is performed afterwards.

As another example, wherein, before the step of (a), the method further includes steps of: (a01) on condition that (1) the staking management server has transmitted a specific user wallet address to a specific user terminal in response to a staking request for a-th primary stakable tokens, which correspond to one type of the primary stakable tokens, from the specific user terminal, (2) a content providing server has transmitted first use permission request transaction information to be used for requesting permission to use the a-th primary stakable tokens to the staking management server and then the staking management server has transmitted first hashed use permission request transaction information, generated by hashing the first use permission request transaction information, to the content providing server, (3) the content providing server has transmitted first staking request transaction information to the staking management server and then the staking management server has transmitted first hashed staking request transaction information, generated by hashing the first staking request transaction information, to the content providing server, and (4) the content providing server has transmitted the first hashed use permission request transaction information and the first hashed staking request transaction information to the specific user terminal, the staking management server (i) receiving a signing request on the first hashed use permission request transaction information and the first hashed staking request transaction information from the specific user terminal, (ii) generating a first specific user signature value by signing the first hashed use permission request transaction information and the first hashed staking request transaction information with a specific user key, and (iii) transmitting the first specific user signature value to the specific user terminal; (a02) (i) on condition that (1) the specific user terminal has transmitted the first hashed use permission request transaction information, the first hashed staking request transaction information and the first specific user signature value to the content providing server, and (2) the content providing server has transmitted second use permission request transaction information, including the first hashed use permission request transaction information and the first specific user signature value, to the staking management server, the staking management server invoking a token management contract to execute a token use permission request function whose parameters include a token staking contract address and a staked quantity of the a-th primary stakable tokens, to thereby receive a-th primary stakable token use permission request processing information and transmit the a-th primary stakable token use permission request processing information to the content providing server; (ii) on condition that the content providing server has transmitted second staking request transaction information, including the first hashed staking request transaction information and the first specific user signature value, to the staking management server, the staking management server invoking a token staking contract to execute a token staking request function whose parameters include the staked quantity of the a-th primary stakable tokens, to thereby receive a-th primary stakable token staking processing information, transmit the a-th primary stakable token staking processing information to the content providing server, and instruct the content providing server to transmit the a-th primary stakable token staking processing information to the specific user terminal.

As another example, wherein, at the step of (a01), on condition that the specific user terminal has logged into an electronic wallet application interworking with the staking management server and transmitted a staking request for the primary stakable tokens to the staking management server, the staking management server acquires the specific user wallet address corresponding to the specific user via the electronic wallet application and transmits the specific user wallet address along with information on the token management contract address, the token staking contract address, a name of the token use permission request function and a name of the token staking request function to the specific user terminal.

As another example, wherein the method further includes steps of: (a03) on condition that (1) the staking management server has transmitted the specific user wallet address to the specific user terminal in response to a staking request for b-th primary stakable tokens, which correspond to one type of the primary stakable tokens, from the specific user terminal, (2) the content providing server has transmitted third use permission request transaction information to be used for requesting permission to use the b-th primary stakable tokens to the staking management server and then the staking management server has transmitted third hashed use permission request transaction information, generated by hashing the third use permission request transaction information, to the content providing server, (3) the content providing server has transmitted third staking request transaction information to the staking management server and then the staking management server has transmitted third hashed staking request transaction information, generated by hashing the third staking request transaction information, to the content providing server, and (4) the content providing server has transmitted the third hashed use permission request transaction information and the third hashed staking request transaction information to the specific user terminal, the staking management server (i) receiving a signing request on the third hashed use permission request transaction information and the third hashed staking request transaction information from the specific user terminal, (ii) generating a second specific user signature value by signing the third hashed use permission request transaction information and the third hashed staking request transaction information with the specific user key, and (iii) transmitting the second specific user signature value to the specific user terminal; (a04) (i) on condition that (1) the specific user terminal has transmitted the third hashed use permission request transaction information, the third hashed staking request transaction information and the second specific user signature value to the content providing server, and (2) the content providing server has transmitted fourth use permission request transaction information, including the third hashed use permission request transaction information and the second specific user signature value, to the staking management server, the staking management server invoking the token management contract to execute the token use permission request function whose parameters include the token staking contract address and a staked quantity of the b-th primary stakable tokens, to thereby receive b-th primary stakable token use permission request processing information and transmit the b-th primary stakable token use permission request processing information to the content providing server; (ii) on condition that the content providing server has transmitted fourth staking request transaction information, including the third hashed staking request transaction information and the second specific user signature value, to the staking management server, the staking management server invoking the token staking contract to execute the token staking request function whose parameters include the staked quantity of the b-th primary stakable tokens, to thereby receive b-th primary stakable token staking processing information, transmit the b-th primary stakable token staking processing information to the content providing server, and instruct the content providing server to transmit the b-th primary stakable token staking processing information to the specific user terminal; wherein the steps of (a03) and (a04) are performed independently from the steps of (a01) and (a02), and each payout ratio of the secondary stakable tokens to each of the a-th primary stakable tokens and the b-th primary stakable tokens is determined according to predetermined conditions.

As another example, wherein the method further includes steps of: (c) on condition that (1) the staking management server has transmitted the specific user wallet address to the specific user terminal in response to a token reward request for the primary stakable tokens, among at least one type of the a-th primary stakable tokens and the b-th primary stakable tokens, (2) the content providing server has transmitted first reward request transaction information to be used for requesting rewards for the primary stakable tokens, among at least one type of the a-the primary stakable tokens and the b-th primary stakable tokens, to the staking management server and then the staking management server has transmitted first hashed reward request transaction information, generated by hashing the first reward request transaction information, to the content providing server, (3) the content providing server has transmitted the first hashed reward request transaction information to the specific user terminal, the staking management server (i) receiving a signing request on the first hashed reward request transaction information from the specific user terminal, (ii) generating a third specific user signature value by signing the first hashed reward request transaction information with the specific user key, and (iii) transmitting the third specific user signature value to the specific user terminal; (d) on condition that (1) the specific user terminal has transmitted the first hashed reward request transaction information and the third specific user signature value to the content providing server, and (2) the content providing server has transmitted second reward request transaction information, including the first hashed reward request transaction information and the third specific user signature value, to the staking management server, the staking management server invoking a token reward contract to execute a token reward request function whose parameters include a token reward contract address, to thereby receive token reward processing information on the primary stakable tokens, among at least one type of the a-the primary stakable tokens and the b-th primary stakable tokens, and transmit the token reward processing information to the content providing server, and instruct the content providing server to transmit the token reward processing information to the specific user terminal.

In accordance with another aspect of the present disclosure, there is provided a staking management server for determining a payout rate of secondary stakable tokens by referring to staking information on primary stakable tokens of a specific user, including: at least one memory that stores instructions; and at least one processor configured to execute the instructions to perform or support another device to perform: (I) a process of determining, as a first stake-related partial index, a first ratio of a cumulative issuance volume of the secondary stakable tokens, acquired from an issuance volume of the secondary stakable tokens per block, to a total staked quantity of the primary stakable tokens acquired by summing up each of the staked quantities of the primary stakable tokens of each of all users who have staked the primary stakable tokens in a specific staking pool, wherein the first stake-related partial index has its corresponding value calculated and stored whenever a specific transaction, selected among a token staking transaction, a token unstaking transaction and a token reward request transaction, occurs by any user among all the users participating in the specific staking pool, and (II) a process of determining a first specific user stake-related index by referring to a specific value of the first stake-related partial index, stored as a result of the specific transaction being generated by the specific user among all the users, and a process of updating a current first total stake-related index by referring to a last value of the first stake-related partial index, stored as a result of generating, as a most recent transaction, any one of the token staking transaction, the token unstaking transaction and the token reward request transaction, wherein, at the process of (II), in response to the most recent transaction being determined as the token reward request transaction generated as the specific transaction by the specific user at a specific block, the processor (i) updates the current first total stake-related index by referring to the last value of the first stake-related partial index, stored as a result of generating the token reward request transaction as the most recent transaction, (ii) determines a first reward basis value as a specific user reward token quantity corresponding to the specific user, wherein the first reward basis value is generated by referring to a specific staked quantity of the primary stakable tokens corresponding to the specific user and a difference between the current first total stake-related index and a previous first specific user stake-related index of the specific user stored prior to updating to the first specific user stake-related index according to the last value of the first stake-related partial index stored as a result of generating the token reward request transaction as the specific transaction, and (iii) updates the previous first specific user stake-related index to the first specific user stake-related index by referring to the last value of the first stake-related partial index stored as a result of generating the token reward request transaction as the specific transaction.

As one example, wherein, at the process of (II), in response to the token reward request transaction being generated at a (k_n)-th block, which is the specific block, the processor (i) acquires the current first total stake-related index by summing up each value of the first stake-related partial index calculated from each of a (k_1)-st block to the (k_n)-th block at which any of the token staking transaction, the token unstaking transaction and the token reward request transaction has occurred, among a first block to a p-th block generated up to a current point of time, and (ii) acquires the previous first specific user stake-related index by summing each value of the first stake-related partial index calculated from each of the (k_1)-st block to a (k_m)-th block as a result of generating any one of the token staking transaction, the token unstaking transaction and the token reward request transaction at the (k_m)-th block, which is a block previous to the (k_n)-th block, by the specific user who requested the token reward request transaction.

As another example, wherein, at the process of (II), the processor accumulates a unit point for calculating additional payouts at each block according to each staked period of a 1-st user to a z-th user, generates a second reward basis value by referring to the unit point for calculating additional payouts and the first reward basis value, and determines a specific user secondary stakable token quantity corresponding to the specific user by referring to the second reward basis value, wherein, in response to a first reward-requesting user, among the 1-st user to the z-th user, having staked the primary stakable tokens by a certain number of blocks later than a second reward-requesting user, the processor assigns a penalty of a predetermined penalty condition to a first secondary stakable token quantity of the first reward-requesting user, and determines the second reward basis value by assigning a reward of a predetermined reward condition corresponding to the penalty to a second secondary stakable token quantity of the second reward-requesting user.

As another example, wherein, starting from an (L_2)-nd block succeeding an (L_1)-st block in which the specific user corresponding to any one of the 1-st user to the z-th user has begun staking the primary stakable tokens, the processor accumulates, as the unit point for calculating additional payouts at each block, a ratio of a cumulative number of blocks, corresponding to a staked period starting from the (L_2)-nd block, to a total number of blocks generated within a specific period of time in which the unit point for calculating additional payouts is accumulatively calculated.

As another example, wherein the processor (i) determines, as a unit point for calculating additional payouts of the specific user, the unit point for calculating additional payouts accumulated for the specific user at an (L_i)-th block generated by a specific number of blocks later than an (L_2)-nd block, succeeding an (L_1)-st block in which the specific user corresponding to any one of the 1-st user to the z-th user has begun staking the primary stakable tokens, and (ii) determines, as a unit point for calculating additional payouts of all the users, a sum of the unit point for calculating additional payouts accumulated for each of all the users at the (L_i)-th block, and wherein, in response to the token reward request transaction being generated at a (k_n)-th block, which is the specific block, the processor (i) (i−1) for each of a (k_1)-st block to the (k_n)-th block, at which any of the token staking transaction, the token unstaking transaction and the token reward request transaction has occurred, among a first block to a p-th block generated up to a current point of time, sets a (2_1)-st ratio to a (2_n)-th ratio of the cumulative issuance volume of the secondary stakable tokens to each of sums of each of total staked quantities of the primary stakable tokens corresponding to each of the (k_1)-st block to the (k_n)-th block and each unit point for calculating additional payouts of all the users corresponding to each of the (k_1)-st block to the (k_n)-th block, as a (2_1)-st stake-related partial index to a (2_n)-th stake-related partial index, and acquires a current second total stake-related index by summing up each of the (2_1)-st stake-related partial index to the (2_n)-th stake-related partial index, and (i−2) as a result of generating any one of the token staking transaction, the token unstaking transaction and the token reward request transaction at a (k_m)-th block, which is a block previous to the (k_n)-th block, by the specific user who requested the token reward request transaction, sets, at each of the (k_1)-st block to the (k_m)-th block, a (3_1)-st ratio to a (3_m)-th ratio of the cumulative issuance volume of the secondary stakable tokens to each of sums of each of total staked quantities of the primary stakable tokens corresponding to each of the (k_1)-st block to the (k_m)-th block and each unit point for calculating additional payouts of all the users corresponding to each of the (k_1)-st block to the (k_m)-th block, as a (3_1)-st stake-related partial index to a (3_m)-th stake-related partial index, and acquires a second specific user stake-related index by summing up each of the (3_1)-st stake-related partial index to the (3_m)-th stake-related partial index, and (ii) generates the second reward basis value by referring to the specific staked quantity of the primary stakable tokens corresponding to the specific user, the unit point for calculating additional payouts of the specific user, and a difference between the current second total stake-related index and the second specific user stake-related index, and determines specific user secondary stakable token quantity corresponding to the specific user by referring to the second reward basis value.

As another example, wherein, at the process of (II), when the specific transaction, which is the token reward request transaction generated by the specific user, occurs at a same block as another transaction, which is any one of the token staking transaction and the token unstaking transaction generated by another user, the specific transaction is performed first and then the another transaction is performed afterwards.

As another example, wherein, before the process of (I), the processor further performs processes of: (I01) on condition that (1) the processor has transmitted a specific user wallet address to a specific user terminal in response to a staking request for a-th primary stakable tokens, which correspond to one type of the primary stakable tokens, from the specific user terminal, (2) a content providing server has transmitted first use permission request transaction information to be used for requesting permission to use the a-th primary stakable tokens to the processor and then the processor has transmitted first hashed use permission request transaction information, generated by hashing the first use permission request transaction information, to the content providing server, (3) the content providing server has transmitted first staking request transaction information to the processor and then the processor has transmitted first hashed staking request transaction information, generated by hashing the first staking request transaction information, to the content providing server, and (4) the content providing server has transmitted the first hashed use permission request transaction information and the first hashed staking request transaction information to the specific user terminal, the processor (i) receiving a signing request on the first hashed use permission request transaction information and the first hashed staking request transaction information from the specific user terminal, (ii) generating a first specific user signature value by signing the first hashed use permission request transaction information and the first hashed staking request transaction information with a specific user key, and (iii) transmitting the first specific user signature value to the specific user terminal; (I02) (i) on condition that (1) the specific user terminal has transmitted the first hashed use permission request transaction information, the first hashed staking request transaction information and the first specific user signature value to the content providing server, and (2) the content providing server has transmitted second use permission request transaction information, including the first hashed use permission request transaction information and the first specific user signature value, to the processor, the processor invoking a token management contract to execute a token use permission request function whose parameters include a token staking contract address and a staked quantity of the a-th primary stakable tokens, to thereby receive a-th primary stakable token use permission request processing information and transmit the a-th primary stakable token use permission request processing information to the content providing server; (ii) on condition that the content providing server has transmitted second staking request transaction information, including the first hashed staking request transaction information and the first specific user signature value, to the processor, the processor invoking a token staking contract to execute a token staking request function whose parameters include the staked quantity of the a-th primary stakable tokens, to thereby receive a-th primary stakable token staking processing information, transmit the a-th primary stakable token staking processing information to the content providing server, and instruct the content providing server to transmit the a-th primary stakable token staking processing information to the specific user terminal.

As another example, wherein, at the process of (I01), on condition that the specific user terminal has logged into an electronic wallet application interworking with the processor and transmitted a staking request for the primary stakable tokens to the processor, the processor acquires the specific user wallet address corresponding to the specific user via the electronic wallet application and transmits the specific user wallet address along with information on the token management contract address, the token staking contract address, a name of the token use permission request function and a name of the token staking request function to the specific user terminal.

As another example, wherein the processor further performs processes of: (I03) on condition that (1) the processor has transmitted the specific user wallet address to the specific user terminal in response to a staking request for b-th primary stakable tokens, which correspond to one type of the primary stakable tokens, from the specific user terminal, (2) the content providing server has transmitted third use permission request transaction information to be used for requesting permission to use the b-th primary stakable tokens to the processor and then the processor has transmitted third hashed use permission request transaction information, generated by hashing the third use permission request transaction information, to the content providing server, (3) the content providing server has transmitted third staking request transaction information to the processor and then the processor has transmitted third hashed staking request transaction information, generated by hashing the third staking request transaction information, to the content providing server, and (4) the content providing server has transmitted the third hashed use permission request transaction information and the third hashed staking request transaction information to the specific user terminal, the processor (i) receiving a signing request on the third hashed use permission request transaction information and the third hashed staking request transaction information from the specific user terminal, (ii) generating a second specific user signature value by signing the third hashed use permission request transaction information and the third hashed staking request transaction information with the specific user key, and (iii) transmitting the second specific user signature value to the specific user terminal; (I04) (i) on condition that (1) the specific user terminal has transmitted the third hashed use permission request transaction information, the third hashed staking request transaction information and the second specific user signature value to the content providing server, and (2) the content providing server has transmitted fourth use permission request transaction information, including the third hashed use permission request transaction information and the second specific user signature value, to the processor, the processor invoking the token management contract to execute the token use permission request function whose parameters include the token staking contract address and a staked quantity of the b-th primary stakable tokens, to thereby receive b-th primary stakable token use permission request processing information and transmit the b-th primary stakable token use permission request processing information to the content providing server; (ii) on condition that the content providing server has transmitted fourth staking request transaction information, including the third hashed staking request transaction information and the second specific user signature value, to the processor, the processor invoking the token staking contract to execute the token staking request function whose parameters include the staked quantity of the b-th primary stakable tokens, to thereby receive b-th primary stakable token staking processing information, transmit the b-th primary stakable token staking processing information to the content providing server, and instruct the content providing server to transmit the b-th primary stakable token staking processing information to the specific user terminal; wherein the processes of (I03) and (I04) are performed independently from the processes of (I01) and (I02), and each payout ratio of the secondary stakable tokens to each of the a-th primary stakable tokens and the b-th primary stakable tokens is determined according to predetermined conditions.

As another example, wherein the processor further performs processes of: (III) on condition that (1) the processor has transmitted the specific user wallet address to the specific user terminal in response to a token reward request for the primary stakable tokens, among at least one type of the a-th primary stakable tokens and the b-th primary stakable tokens, (2) the content providing server has transmitted first reward request transaction information to be used for requesting rewards for the primary stakable tokens, among at least one type of the a-the primary stakable tokens and the b-th primary stakable tokens, to the processor and then the processor has transmitted first hashed reward request transaction information, generated by hashing the first reward request transaction information, to the content providing server, (3) the content providing server has transmitted the first hashed reward request transaction information to the specific user terminal, the processor (i) receiving a signing request on the first hashed reward request transaction information from the specific user terminal, (ii) generating a third specific user signature value by signing the first hashed reward request transaction information with the specific user key, and (iii) transmitting the third specific user signature value to the specific user terminal; (IV) on condition that (1) the specific user terminal has transmitted the first hashed reward request transaction information and the third specific user signature value to the content providing server, and (2) the content providing server has transmitted second reward request transaction information, including the first hashed reward request transaction information and the third specific user signature value, to the processor, the processor invoking a token reward contract to execute a token reward request function whose parameters include a token reward contract address, to thereby receive token reward processing information on the primary stakable tokens, among at least one type of the a-the primary stakable tokens and the b-th primary stakable tokens, and transmit the token reward processing information to the content providing server, and instruct the content providing server to transmit the token reward processing information to the specific user terminal.

In addition, recordable media that are readable by a computer for storing a computer program to execute the method of the present disclosure is further provided.

### BRIEF DESCRIPTION OF THE DRAWINGS

The above and other objects and features of the present disclosure will become apparent from the following description of preferred embodiments given in conjunction with the accompanying drawings. The accompanying drawings used to explain example embodiments of the present disclosure are only part of example embodiments of the present disclosure and other drawings can be obtained based on the drawings by those skilled in the art of the present disclosure without inventive work.

FIG. 1 is a block diagram schematically illustrating a configuration of a system for determining a payout rate of secondary stakable tokens by referring to staking information on primary stakable tokens of a specific user in accordance with one example embodiment of the present disclosure.

FIG. 2 is a drawing schematically illustrating a staking management server capable of determining the payout rate of the secondary stakable tokens by referring to the staking information on the primary stakable tokens of the specific user in accordance with one example embodiment of the present disclosure.

FIG. 3 is a sequence diagram schematically illustrating a process of staking a-th primary stakable tokens, which correspond to one type of the primary stakable tokens, in response to staking request information of the specific user in accordance with one example embodiment of the present disclosure.

FIG. 4 is a sequence diagram schematically illustrating a process of staking b-th primary stakable tokens, which correspond to one type of the primary stakable tokens, in response to the staking request information of the specific user in accordance with one example embodiment of the present disclosure.

FIG. 5 is a sequence diagram schematically illustrating a process of rewarding the secondary stakable tokens in response to a request for a reward made by the specific user for staking the primary stakable tokens for a period of time in accordance with one embodiment of the present invention.

FIG. 6 is a table schematically illustrating an example of a user A, a user B, and a user C, each of whom is part of total users participating in a specific staking pool, staking the primary stakable tokens in the specific staking pool in accordance with one embodiment of the present invention.

FIG. 7 is a table schematically illustrating an example of computing each unit point for calculating additional payouts for each of the user A, the user B, and the user C as a result of the user A, the user B and the user C staking the primary stakable tokens in the specific staking pool in accordance with one embodiment of the present invention.

### DETAILED DESCRIPTION OF THE PREFERRED EMBODIMENTS

The following detailed description of the present disclosure refers to the accompanying drawings, which show by way of illustration a specific embodiment in which the present disclosure may be practiced, in order to clarify the objects, technical solutions and advantages of the present disclosure. These embodiments are described in sufficient detail to enable those skilled in the art to practice the present disclosure.

Besides, in the detailed description and claims of the present disclosure, a term “include” and its variations are not intended to exclude other technical features, additions, components or steps. Other objects, benefits and features of the present disclosure will be revealed to one skilled in the art, partially from the specification and partially from the implementation of the present disclosure. The following examples and drawings will be provided as examples, but they are not intended to limit the present disclosure.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

The headings and abstract of the present disclosure provided herein are for convenience only and do not limit or interpret the scope or meaning of the embodiments.

As used in this specification and the appended claims, the singular forms “a,” “an,” and “the” may include plural referents unless the content and context clearly dictates otherwise.

To allow those skilled in the art to carry out the present disclosure easily, the example embodiments of the present disclosure will be explained by referring to attached diagrams in detail as shown below.

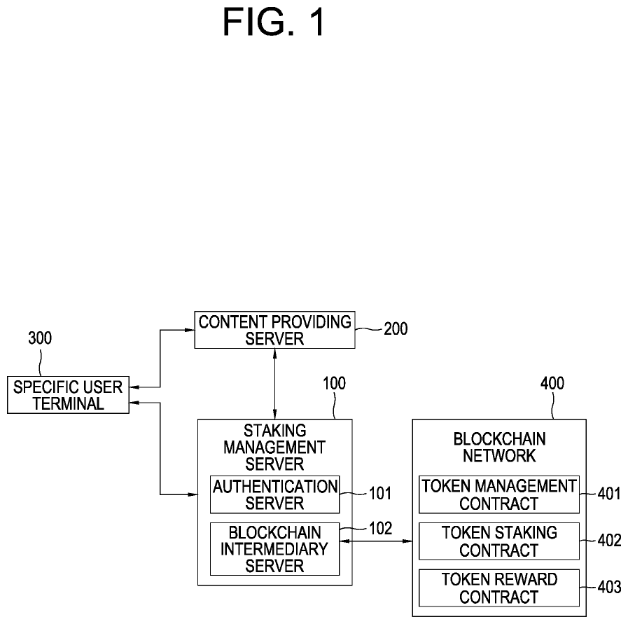

FIG. 1 is a block diagram schematically illustrating a configuration of a system for determining a payout rate of secondary stakable tokens by referring to staking information on primary stakable tokens of a specific user in accordance with one example embodiment of the present disclosure.

By referring to FIG. 1, first, in response to a staking request for the primary stakable tokens from a specific user terminal 300, a staking management server 100 may perform staking processing of the primary stakable tokens through interactions with a content providing server 200, the specific user terminal 300 and a blockchain network 400. In addition, in response to a reward request for the primary stakable tokens from the specific user terminal 300, the staking management server 100 may perform reward processing of the primary stakable tokens through interactions with the content providing server 200, the specific user terminal 300 and the blockchain network 400, thereby providing the secondary stakable tokens corresponding to the primary stakable tokens staked for a certain period of time to the specific user terminal 300.

Further, the staking management server 100 may calculate a share on the secondary stakable tokens for which the specific user is eligible to be rewarded according to the staking information, i.e., staked quantity and staked period, corresponding to the primary stakable tokens staked by each of all users participating in a specific staking pool. Then, the staking management server 100 may compute each of unit points for calculating additional payouts which is determined for each of the users according to each of staked quantities and each of staked periods related to the primary stakable tokens staked by each of the users participating in the specific staking pool. Following, the staking management server 100 may determine an amount of the secondary stakable tokens to be distributed to the specific user by referring to each of the staked quantities, each of the staked periods, each of the shares and each of the unit points for calculating additional payouts related to the primary stakable tokens staked by each of the users, thereby distributing the secondary stakable tokens to the specific user terminal 300.

Also, the staking management server 100 may include an authentication server 101 and a blockchain intermediary server 102. Herein, each of the authentication server 101 and the blockchain intermediary server 102 included in the staking management server 100 may be implemented as a physical server or a software server. As another example, at least some of the authentication server 101 and the blockchain intermediary server 102 may not be included within the staking management server 100. For reference, the claims of this specification are described in terms of the staking management server 100. This may be construed as the staking management server 100 itself performing processes as a unified entity, but it is possible that each of the authentication server 101 and the blockchain intermediary server 102 may be construed as performing the same processes as individual entities (although the claims do not mention the authentication server 101 and the blockchain intermediary server 102 per se). This is because various implementations of the server(s) may be readily derived by those skilled in the art.

Herein, the authentication server 101 may be a server that authenticates a user and transmits a specific user wallet address to the specific user terminal 300. Also, herein, the blockchain intermediary server 102 may be a server that receives transaction information from the content providing server 200 and transmits its corresponding transaction to the blockchain network 400.

Next, the content providing server 200 may function as a server that provides at least one content to users who utilize the content related to staking tokens, unstaking tokens (unstaking means reclaiming of staked tokens by the users), and claiming tokens (claiming means requesting the secondary stakable tokens as reward tokens according to the staked quantity and the staked period of the primary stakable tokens), although examples of the content provided by the content providing server 200 are not limited to this and many variations are possible. For reference, the content in the present disclosure may be, but is not limited to, a game content.

In addition, the blockchain network 400 may be a network that interacts with the blockchain intermediary server 102 and stores transactions. Further, a token management contract 401, a token staking contract 402, and a token reward contract 403 included in the blockchain network 400 may play a role in respectively executing a token use permission request function, a token staking request function, and a token reward request function, thereby allowing its corresponding transaction information to be processed.

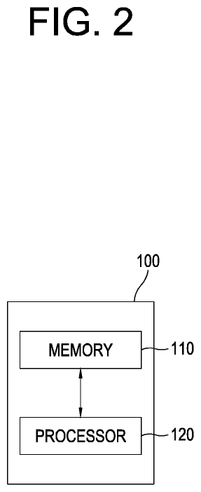

FIG. 2 is a drawing schematically illustrating the staking management server capable of determining the payout rate of the secondary stakable tokens by referring to the staking information on the primary stakable tokens of the specific user in accordance with one example embodiment of the present disclosure.

By referring to FIG. 2, the staking management server 100 may include a memory 110 for storing instructions to determine the payout rate of the secondary stakable tokens by referring to the staking information on the primary stakable tokens of the specific user, and a processor 120 for determining the payout rate of the secondary stakable tokens by referring to the staking information on the primary stakable tokens of the specific user according to the instructions in the memory 110. Herein, the memory 110 of the staking management server 100 may store the instructions to be performed by the processor 120 and specifically, the instructions may be code generated for the purpose of instructing the staking management server 100 to function in a particular manner and may be stored in a computer-usable or computer-readable memory capable of being directed to a computer or other programmable data processing equipment. The instructions may perform processes to execute functions described in the specification of the present disclosure.

The processor 120 of the staking management server 100 may include hardware configuration of MPU (Micro Processing Unit) or CPU (Central Processing Unit), Cache Memory, Data Bus, etc. Additionally, the computing device may further include OS and software configuration of applications that achieve specific purposes.

Additionally, the staking management server 100 may be linked to a database (not shown). Herein, the database (not shown) may include at least one type of storage medium among a flash memory type, hard disk type, multimedia card micro type, card-type memory (for example, SD or XD memory), Random Access Memory (RAM), Static Random Access Memory (SRAM), ReadOnly Memory (ROM), Electrically Erasable Programmable ReadOnly Memory (EEPROM), Programmable ReadOnly Memory (PROM), magnetic memory, magnetic disk, and optical disk, but is not limited to this and may include any medium capable of storing data.

In addition, although not shown in FIG. 2, the content providing server 200 and the specific user terminal 300 may also be configured to include respective memories and processes.

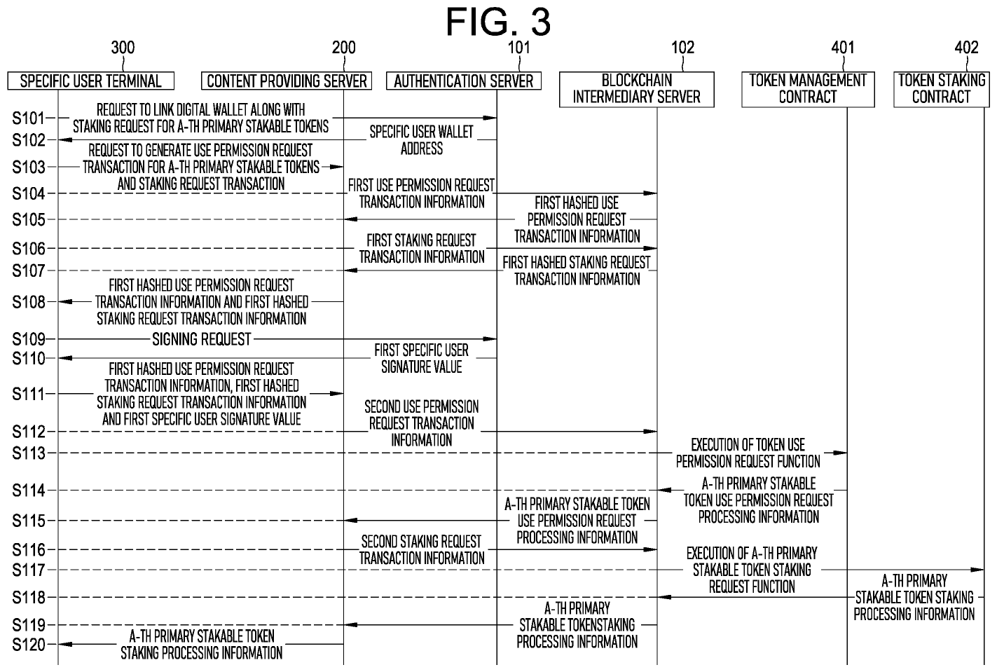

FIG. 3 is a sequence diagram schematically illustrating a process of staking the primary stakable tokens in response to staking request information of the specific user in accordance with one example embodiment of the present disclosure.

Before describing a method of determining the payout rate of the secondary stakable tokens by referring to the staking information on the primary stakable tokens of the specific user, the process of staking the primary stakable tokens in response to the staking request information of the specific user will be first described.

Herein, the secondary stakable tokens may be the reward tokens provided to the user through staking of at least one type of the primary stakable tokens. Herein, the primary stakable token may be of one type, but hereinafter, it is assumed that there are multiple types, and thus staking of a-th primary stakable tokens and b-th primary stakable tokens is explained by way of example.

By referring to FIG. 3, the specific user terminal 300 may first make a staking request for the a-th primary stakable tokens, which correspond to one type among various types of the primary stakable tokens, to the authentication server 101, along with a request for linking of an electronic wallet, at a step of S101. Of course, the step of S101 may also assume a case where there is only one type of the primary stakable tokens, in which case the step S101 may be interpreted as requesting staking of that one type of primary stakable tokens along with the request to connect the electronic wallet. Further, since the same is true for subsequent steps to be explained below, explanation on the case where there is only one type of token available for the primary stakable tokens will be omitted below. Following, the authentication server 101 may verify the user and then transmit the specific user wallet address to the specific user terminal 300 at a step of S102. At this time, when the staking management server 100 receives a staking request of the a-th primary stakable tokens from the specific user terminal 300 while the specific user is logged in to an electronic wallet app operating in conjunction with the staking management server 100, the staking management server 100 may obtain the specific user wallet address corresponding to the specific user through the electronic wallet app, and transmit information on a token management contract address, a token staking contract address, a name of the token use permission request function, and a name of the token staking request function along with the specific user wallet address to the specific user terminal 300.

Additionally, in response to receiving requests for generating a use permission request transaction and a staking request transaction corresponding to the a-th primary stakable tokens from the specific user terminal 300 at a step of S103, the content providing server 200 may transmit first use permission request transaction information to be used for requesting permission to use the a-th primary stakable tokens to the blockchain intermediary server 102 at a step of S104. Next, the blockchain intermediary server 102 may transmit first hashed use permission request transaction information, generated by hashing the first use permission request transaction information, to the content providing server 200 at a step of S105, and then the content providing server 200 may transmit first staking request transaction information to the blockchain intermediary server 102 at a step of S106. Following, the blockchain intermediary server 102 may transmit first hashed staking request transaction information, generated by hashing the first staking request transaction information, to the content providing server 200 at a step of S107.

In addition, the content providing server 200 may transmit the first hashed use permission request transaction information and the first hashed staking request transaction information to the specific user terminal 300 at a step of S108. Then, the specific user terminal 300 may request signing on the first hashed use permission request transaction information and the first hashed staking request transaction information to the authentication server 101 at a step of S109. Following, the authentication server 101 may generate a first specific user signature value by signing the first hashed use permission request transaction information and the first hashed staking request transaction information with a specific user key and transmit the first specific user signature value to the specific user terminal 300 at a step of S110.

Next, the specific user terminal 300 may transmit the first hashed use permission request transaction information, the first hashed staking request transaction information and the first specific user signature value to the content providing server 200 at a step of S111. Then, the content providing server 200 may transmit second use permission request transaction information, including the first hashed use permission request transaction information and the first specific user signature value, to the blockchain intermediary server at a step of S112.

In addition, the blockchain intermediary server 102 may invoke the token management contract 401 included in the blockchain network 400 to execute the token use permission request function whose parameters include the token staking contract address and a staked quantity of the a-th primary stakable tokens at a step of S113, to thereby receive a-th primary stakable token use permission request processing information at a step of S114. Then, the blockchain intermediary server 102 may transmit the a-th primary stakable token use permission request processing information to the content providing server 200 at a step of S115.

Next, the content providing server 200 may transmit second staking request transaction information, including the first hashed staking request transaction information and the first specific user signature value, to the blockchain intermediary server 102 at a step of S116.

Additionally, the blockchain intermediary server 102 may invoke the token staking contract 402 included in the blockchain network 400 to execute an a-th primary stakable token staking request function whose parameters include the staked quantity of the a-th primary stakable tokens at a step of S117, to thereby receive a-th primary stakable token staking processing information at a step of S118. Then, the blockchain intermediary server 102 may transmit the a-th primary stakable token staking processing information to the content providing server 200 at a step of S119. Herein, when the token staking contract 402 executes the a-th primary stakable token staking request function, the token staking contract 402 may internally call an a-th token staking contract corresponding to the a-th primary stakable tokens to process staking of the a-th primary stakable tokens, but the present disclosure is not limited thereto.

Following, in response to receiving the a-th primary stakable token staking processing information, the content providing server 200 may transmit the a-th primary stakable token staking processing information to the specific user terminal 300 at a step of S120.

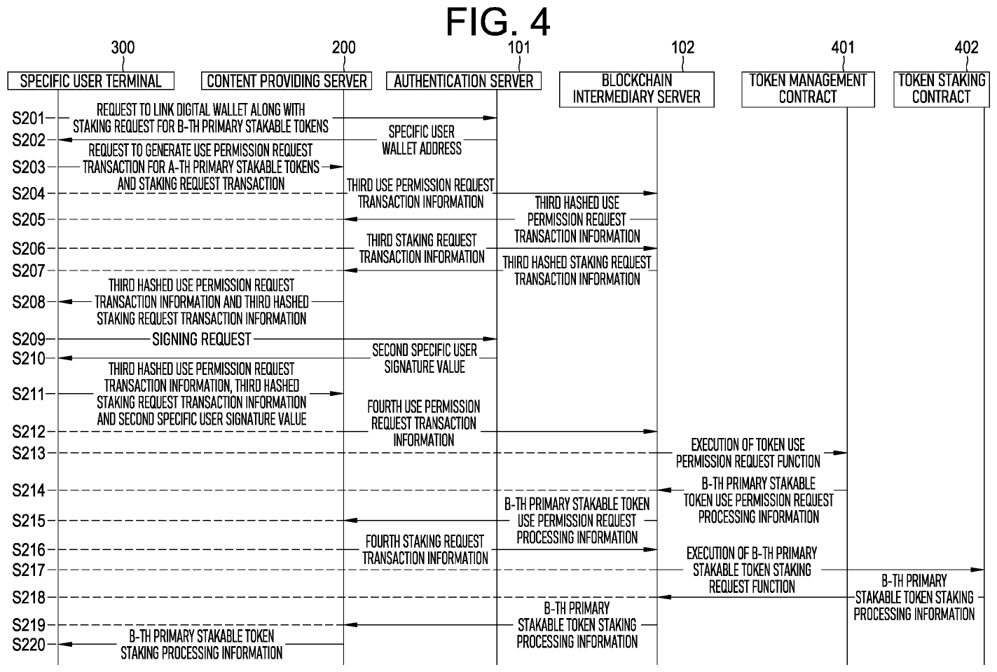

Herein, FIG. 3 describes the staking process of the a-th primary stakable tokens, which correspond to one type of the primary stakable tokens, but the example will be equally applicable to the staking of the b-th primary stakable tokens, which also correspond to another type of the primary stakable tokens. FIG. 4 below illustrates a staking process of the b-th primary stakable tokens.

FIG. 4 is a sequence diagram schematically illustrating a process of staking b-th primary stakable tokens, which correspond to one type of the primary stakable tokens, in response to staking request information of the specific user in accordance with one example embodiment of the present disclosure.

By referring to FIG. 4, the specific user terminal 300 may first make a staking request for the b-th primary stakable tokens, which correspond to one type among various types of the primary stakable tokens, to the authentication server 101, along with the request for linking of the electronic wallet, at a step of S201. Of course, the step of S201 may also assume a case where there is only one type of the primary stakable tokens, in which case the step S201 may be interpreted as requesting staking of that one type of primary stakable tokens along with the request to connect the electronic wallet. Further, since the same is true for subsequent steps to be explained below, explanation on the case where there is only one type of token available for the primary stakable tokens will be omitted below. Following, the authentication server 101 may verify the user and then transmit the specific user wallet address to the specific user terminal 300 at a step of S202. At this time, when the staking management server 100 receives a staking request of the b-th primary stakable tokens from the specific user terminal 300 while the specific user is logged in to the electronic wallet app operating in conjunction with the staking management server 100, the staking management server 100 may obtain the specific user wallet address corresponding to the specific user through the electronic wallet app, and transmit information on a token management contract address, a token staking contract address, a name of the token use permission request function, and a name of the token staking request function along with the specific user wallet address to the specific user terminal 300.

Additionally, in response to receiving requests for generating a use permission request transaction and a staking request transaction corresponding to the b-th primary stakable tokens from the specific user terminal 300 at a step of S203, the content providing server 200 may transmit third use permission request transaction information to be used for requesting permission to use the b-th primary stakable tokens to the blockchain intermediary server 102 at a step of S204. Then, the blockchain intermediary server 102 may transmit third hashed use permission request transaction information, generated by hashing the third use permission request transaction information, to the content providing server 200 at a step of S205.

Next, the content providing server 200 may transmit third staking request transaction information to the blockchain intermediary server 102 at a step of S06. Then, the blockchain intermediary server 102 may transmit third hashed staking request transaction information, generated by hashing the third staking request transaction information, to the content providing server 200 at a step of S207.

In addition, the content providing server 200 may transmit the third hashed use permission request transaction information and the third hashed staking request transaction information to the specific user terminal 300 at a step of S208. Then, the specific user terminal 300 may request signing on the third hashed use permission request transaction information and the third hashed staking request transaction information to the authentication server 101 at a step of S209. Following, the authentication server 101 may generate a second specific user signature value by signing the third hashed use permission request transaction information and the third hashed staking request transaction information with the specific user key and transmit the second specific user signature value to the specific user terminal 300 at a step of S210.

Next, the specific user terminal 300 may transmit the third hashed use permission request transaction information, the third hashed staking request transaction information and the second specific user signature value to the content providing server 200 at a step of S211. Then, the content providing server 200 may transmit fourth use permission request transaction information, including the third hashed use permission request transaction information and the second specific user signature value, to the blockchain intermediary server at a step of S212.

In addition, the blockchain intermediary server 102 may invoke the token management contract 401 included in the blockchain network 400 to execute the token use permission request function whose parameters include the token staking contract address and a staked quantity of the b-th primary stakable tokens at a step of S213, to thereby receive b-th primary stakable token use permission request processing information at a step of S214. Then, the blockchain intermediary server 102 may transmit the b-th primary stakable token use permission request processing information to the content providing server 200 at a step of S215.

Next, the content providing server 200 may transmit fourth staking request transaction information, including the third hashed staking request transaction information and the second specific user signature value, to the blockchain intermediary server 102 at a step of S216.

Additionally, the blockchain intermediary server 102 may invoke the token staking contract 402 included in the blockchain network 400 to execute a b-th primary stakable token staking request function whose parameters include the staked quantity of the b-th primary stakable tokens at a step of S217, to thereby receive b-th primary stakable token staking processing information at a step of S218. Then, the blockchain intermediary server 102 may transmit the b-th primary stakable token staking processing information to the content providing server 200 at a step of S219. Herein, when the token staking contract 402 executes the b-th primary stakable token staking request function, the token staking contract 402 may internally call a b-th token staking contract corresponding to the b-th primary stakable tokens to process staking of the b-th primary stakable tokens, but the present disclosure is not limited thereto.

Following, in response to receiving the b-th primary stakable token staking processing information, the content providing server 200 may transmit the b-th primary stakable token staking processing information to the specific user terminal 300 at a step of S220.

At this time, the staking process of the a-th primary stakable tokens and the staking process of the b-th primary stakable tokens are performed independently with each other, and each payout ratio of the secondary stakable tokens for each of the a-th primary stakable tokens and the b-th primary stakable tokens may be determined according to each of predetermined conditions. For example, by referring to each of circulation volumes for each of the a-th primary stakable tokens and the b-th primary stakable tokens, a higher weight may be given to a certain type of the primary stakable tokens (selected among the a-th primary stakable tokens and the b-th primary stakable tokens) such that a higher reward quantity of the secondary stakable tokens may be paid out for the certain type of the primary stakable tokens even if a same amount of the other type of the primary stakable tokens is staked for a same period, but the present disclosure is not limited thereto.

Next, a process of staking either the a-th primary stakable tokens or the b-th primary stakable tokens by the specific user and then requesting a corresponding reward after a period of time by the specific user will be described.

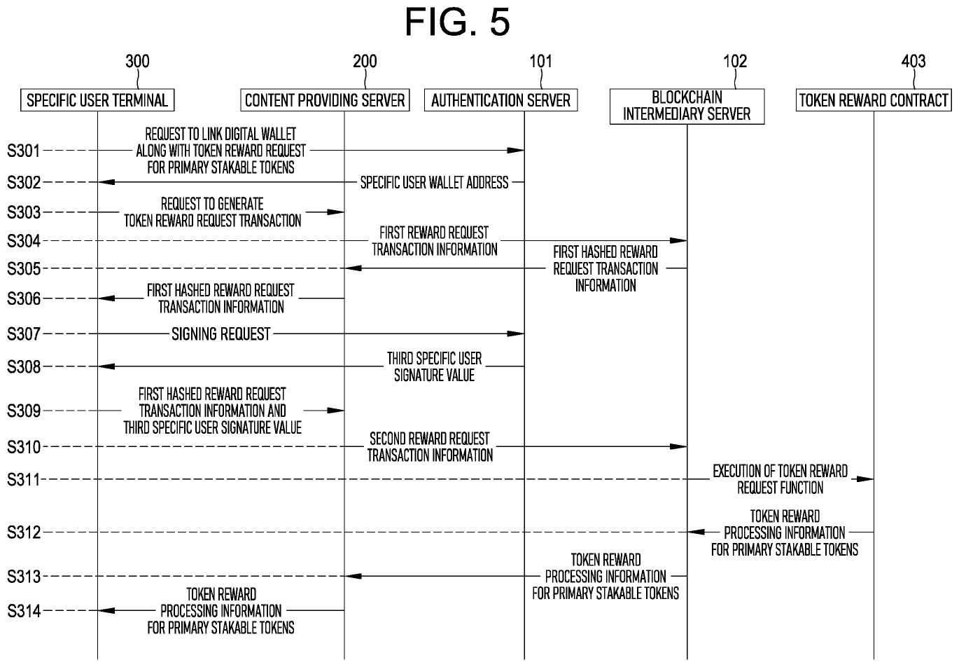

FIG. 5 is a sequence diagram schematically illustrating a process of rewarding the secondary stakable tokens in response to a request for a reward made by the specific user for staking the primary stakable tokens for a period of time in accordance with one embodiment of the present invention.

By referring to FIG. 5, the specific user terminal 300 may first make a token reward request for at least one type of the primary stakable tokens, among the a-th primary stakable tokens and the b-th primary stakable tokens, to the authentication server 101, along with a request for linking of the electronic wallet, at a step of S301. Then, the authentication server 101 may verify the user and then transmit the specific user wallet address to the specific user terminal 300 at a step of S302.

In addition, the specific user terminal 300 may request a generation of reward request transaction to be used for requesting rewards for at least one type of the primary stakable tokens, among the a-the primary stakable tokens and the b-th primary stakable tokens, to the content providing server 200 at a step of S303. Then, the content providing server 200 may transmit first reward request transaction information to be used for requesting rewards for at least one type of the primary stakable tokens, among the a-the primary stakable tokens and the b-th primary stakable tokens, to the blockchain intermediary server 102 at a step of S304.

Further, the blockchain intermediary server 102 may transmit first hashed reward request transaction information, generated by hashing the first reward request transaction information, to the content providing server 200 at a step of S305. Then, the content providing server 200 may transmit the first hashed reward request transaction information to the specific user terminal 300 at a step of S306.

Next, the specific user terminal 300 may request signing on the first hashed reward request transaction information to the authentication server 101 at a step of S307. Following, the authentication server 101 may generate a third specific user signature value by signing the first hashed reward request transaction information with the specific user key, and transmit the third specific user signature value to the specific user terminal 300 at a step of S308.

Further, the specific user terminal 300 may transmit the first hashed reward request transaction information and the third specific user signature value to the content providing server 200 at a step of S309. Then, the content providing server 200 may transmit second reward request transaction information, including the first hashed reward request transaction information and the third specific user signature value, to the blockchain intermediary server at a step of S310.

In addition, the blockchain intermediary server 102 may invoke the token reward contract 403 to execute the token reward request function whose parameters include a token reward contract address at a step of S311, to thereby receive token reward processing information on at least one type of the primary stakable tokens, among the a-the primary stakable tokens and the b-th primary stakable tokens, at a step of S312. Following, the blockchain intermediary server 102 may transmit the token reward processing information on at least one type of the primary stakable tokens, among the a-the primary stakable tokens and the b-th primary stakable tokens, to the content providing server 200 at a step of S313, and then the content providing server 200 may transmit the token reward processing information to the specific user terminal 300 at a step of S314. Herein, the token reward contract 403 may be implemented as a same contract as the token staking contract 402 or the like, but the present disclosure is not limited thereto.

At this time, when the token reward contract 403 executes each token reward request function for each of the a-th primary stakable tokens and the b-th primary stakable tokens, an a-th token reward contract corresponding to the a-th primary stakable tokens and a b-th token reward contract corresponding to the b-th primary stakable tokens may each be called internally to process the reward request for each of the a-th primary stakable tokens and the b-th primary stakable tokens respectively, but the present disclosure is not limited thereto.

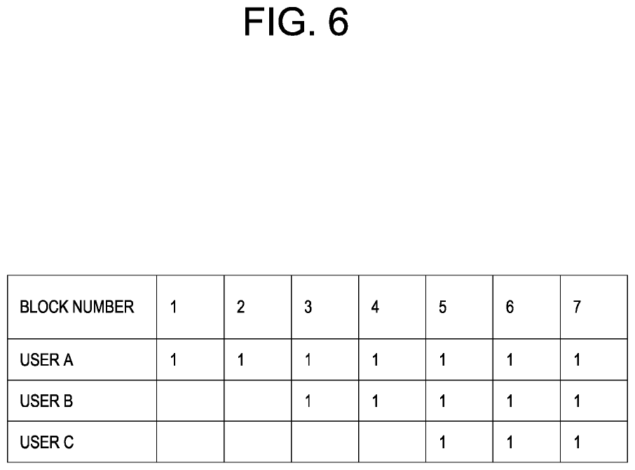

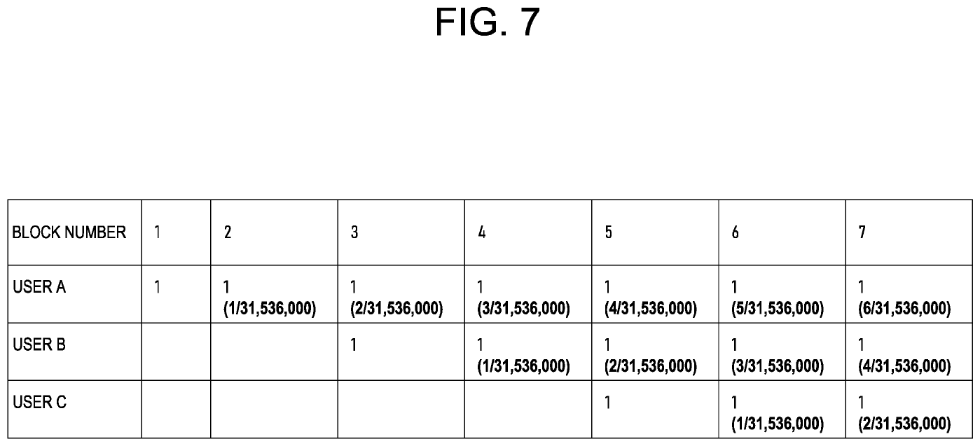

FIGS. 6 and 7 describe a method for calculating the share of the secondary stakable tokens to be reward to the specific user according to each of the staked quantities and each of the staked periods of the primary stakable tokens for each of the users participating in the specific staking pool, and a method for calculating each of the unit points for calculating additional payouts to each of the users according to each of the staked quantities and each of the staked periods of the primary stakable tokens for each of the users participating in the specific staking pool.

FIG. 6 is a table schematically illustrating an example of a user A, a user B, and a user C, each of whom is part of the total users participating in the specific staking pool, staking the primary stakable tokens in the specific staking pool in accordance with one embodiment of the present invention.

By referring to FIG. 6, the top line of the table indicates that one block is generated every second. Also, in this example, the description will be made assuming that a first block to a seventh block have been generated, but examples of the block generation cycle are not limited thereto.

In addition, the number “1” written in the second to fourth lines in FIG. 6 refers to each cumulative staked quantity of the primary stakable tokens corresponding to each user.

For convenience of explanation, it is assumed that there are a total of three users, i.e., the user A, the user B, and the user C, participating in the specific staking pool, and although not shown, the description will be made assuming that an issuance volume of the secondary stakable tokens, i.e., an issuance volume of the reward tokens, per block is 1 token.

First, it is shown that only the user A has staked the primary stakable tokens at the first block, and at a second block as well, no one staked except the user A. However, at a third block, the user B has staked, resulting in a total of two users staking in the specific staking pool. Further, at a fifth block, the user C has staked for the first time in the specific staking pool. Herein, for the sake of illustration, a reward quantity of the secondary stakable tokens for the user A at the third block will be calculated. Of course, the “reward quantity” herein does not imply that the reward is provided to user A in the third block but rather means that the reward quantity is tentatively calculated for the user A.

For reference, when the reward quantity for the user A is calculated at the third block, the reward quantity for the user A up to the second block, which is the previous block, is calculated. In other words, the reward quantity of the user A is calculated by multiplying a ratio of a user staked quantity to a total staked quantity by an issuance volume per block i.e., by following an equation of (the user staked quantity/the total staked quantity)*the issuance volume per block. Herein, as stated above, the issuance volume per block refers to the issuance volume of the secondary stakable tokens. Calculating the reward quantity of the user A using the equation, a reward quantity at the first block is calculated as 1/1*1, and a reward quantity at the second block is calculated as 1/1*1. Therefore, a total of 2 tokens of the secondary stakable tokens are calculated as the reward quantity.

Next, let us assume that the user C has requested a reward for the primary stakable tokens at the seventh block. Then, since the user C started staking at the fifth block, the user C will be rewarded up to the sixth block, which is the block right before the seventh block. In other words, applying the above equation of calculating the reward quantity for staking, a reward quantity at the fifth block for the user C is calculated as ⅓*1, and a reward quantity at the sixth block for the user C is calculated as ⅓*1. Therefore, a total of ⅔ tokens of the secondary stakable tokens are calculated as the reward quantity for the user C.

To summarize, it is deducible that a staking reward quantity for the user(s) may be calculated by applying the equation of (the user staked quantity/the total staked quantity)*the issuance volume per block. However, since an individual does not know the staked quantities of all other users, the above equation may be redefined to use common information available to all the users, namely the issuance per block and the total staked quantity, as follows.

First, the staking management server 100 may determine, as a first stake-related partial index, a first ratio of a cumulative issuance volume of the secondary stakable tokens, acquired from an issuance volume of the secondary stakable tokens per block, to the total staked quantity of the primary stakable tokens acquired by summing up each of the staked quantities of the primary stakable tokens of each of all the users who have staked the primary stakable tokens in the specific staking pool. Herein, the first stake-related partial index has its corresponding value calculated and stored whenever a specific transaction, selected among a token staking transaction, a token unstaking transaction and a token reward request transaction, occurs by any user among all the users participating in the specific staking pool.

Also, the total staked quantity, which is one of the common information used in the equation that needs to be redefined, may refer to the total staked quantity of the primary stakable tokens acquired by summing up each of the staked quantities of the primary stakable tokens for each of all the users who have staked the primary stakable tokens in the specific staking pool, and the issuance volume per block, which is another one of the common information used in the equation that needs to be redefined, may refer to the cumulative issuance volume of the secondary stakable tokens acquired from the issuance volume of the secondary stakable tokens per block.

To summarize, the first stake-related partial index may be computed whenever the specific transaction, selected among the token staking transaction, the token unstaking transaction and the token reward request transaction, occurs by any user among all the users participating in the specific staking pool.

Herein, by referring to FIG. 6 again to explain the first stake-related partial index, a first stake-related partial index at the first block may become a first stake-related partial index of the user A, since the user A has generated the specific transaction, i.e. the token staking transaction, at the first block. To sum this up, the first stake-related partial index at the first block becomes “an issuance volume of the secondary stakable tokens as of the first block/a sum of each of the staked quantities of the primary stakable tokens for each of all the users as of the first block”.

At the third block in which a next specific transaction has occurred, a first stake-related partial index at the third block may become a first stake-related partial index of the user B, since the user B has generated the specific transaction, i.e. the token staking transaction, at the third block. To sum this up, the first stake-related partial index at the third block becomes “(a cumulative issuance volume of the secondary stakable tokens from the first block to the third block−the issuance volume of the secondary stakable tokens as of the first block)/a sum of each of the staked quantities of the primary stakable tokens of each of all users as of the third block”.

At the fifth block in which a next specific transaction has occurred, a first stake-related partial index at the fifth block may become a first stake-related partial index of the user C, since the user C has generated the specific transaction, i.e. the token staking transaction, at the fifth block. To sum this up, the first stake-related partial index at the fifth block becomes “(a cumulative issuance volume of the secondary stakable tokens from the first block to the fifth block−the cumulative issuance volume of the secondary stakable tokens from the first block to the third block)/a sum of each of the staked quantities of the primary stakable tokens of each of all the users as of the fifth block”.

Lastly, assuming that the user C has made another specific transaction, i.e. the token reward request transaction, at the seventh block, a first stake-related partial index at the seventh block may become a first stake-related partial index of the user C. To sum this up, the first stake-related partial index at the seventh block becomes “(a cumulative issuance volume of the secondary stakable tokens from the first block to the seventh block−the cumulative issuance volume of the secondary stakable tokens from the first block to the fifth block)/a sum of each of the staked quantities of the primary stakable tokens of each of all users as of the seventh block”.

In this way, the first stake-related partial index for each block in which each specific transaction occurs may change depending on which user out of all the users made each specific transaction.

Next, the staking management server 100 may perform a process of determining a first specific user stake-related index by referring to a specific value of the first stake-related partial index, stored as a result of the specific transaction being generated by the specific user among all the users, and a process of updating a current first total stake-related index by referring to a last value of the first stake-related partial index, stored as a result of generating, as a most recent transaction, any one of the token staking transaction, the token unstaking transaction and the token reward request transaction.

Herein, in response to the most recent transaction being determined as the token reward request transaction generated as the specific transaction by the specific user at a specific block, the staking management server 100 may update the current first total stake-related index by referring to the last value of the first stake-related partial index, stored as a result of generating the token reward request transaction as the most recent transaction.

Herein, by referring to FIG. 6 again to explain the current first total stake-related index, when the user C has generated the token reward request transaction at the seventh block, the current first total stake-related index at this time becomes a sum of all first stake-related partial indexes determined in response to all transactions occurred to date. That is, to generalize, the current first total stake-related index may be acquired by summing up each value of the first stake-related partial index calculated from each of a (k_1)-st block to a (k_n)-th block at which any of the token staking transaction, the token unstaking transaction and the token reward request transaction has occurred, among a first block to a p-th block generated up to a current point of time.

To summarize, the current first total stake-related index at the seventh block may be determined to be “the issuance volume of the secondary stakable tokens as of the first block/the sum of each of the staked quantities of the primary stakable tokens of each of all the users as of the first block”+“(the cumulative issuance volume of the secondary stakable tokens from the first block to the third block−the issuance volume of the secondary stakable tokens as of the first block)/the sum of each of the staked quantities of the primary stakable tokens of each of all the users as of the third block”+“(the cumulative issuance volume of the secondary stakable tokens from the first block to the fifth block−the cumulative issuance volume of the secondary stakable tokens from the first block to the third block)/the sum of each of the staked quantities of the primary stakable tokens of each of all the users as of the fifth block”+“(the cumulative issuance volume of the secondary stakable tokens from the first block to the seventh block−the cumulative issuance volume of the secondary stakable tokens from the first block to the fifth block)/the sum of each of the staked quantities of the primary stakable tokens of each of all the users as of the seventh block”.

Next, the staking management server 100 may determine a first reward basis value as a specific user reward token quantity corresponding to the specific user, wherein the first reward basis value is generated by referring to a specific staked quantity of the primary stakable tokens corresponding to the specific user and a difference between the current first total stake-related index and a previous first specific user stake-related index of the specific user stored prior to updating to the first specific user stake-related index according to the last value of the first stake-related partial index stored as a result of generating the token reward request transaction as the specific transaction.

Herein, by referring to FIG. 6 again to explain the previous first specific user stake-related index, when the user C has generated the token reward request transaction at the seventh block, the previous first specific user stake-related index at this time becomes a sum of all first stake-related partial indexes determined in response to all the transactions occurred before (or, more precisely, immediately before) the seventh block. That is, the previous first specific user stake-related index may be acquired by summing each value of the first stake-related partial index calculated from each of the (k_1)-st block to a (k_m)-th block as a result of generating any one of the token staking transaction, the token unstaking transaction and the token reward request transaction at the (k_m)-th block, which is a block previous to the (k_n)-th block, by the specific user who requested the token reward request transaction.

To summarize, the previous first specific user stake-related index at the seventh block may be determined to be “the issuance volume of the secondary stakable tokens as of the first block/the sum of each of the staked quantities of the primary stakable tokens of each of all the users as of the first block”+“(the cumulative issuance volume of the secondary stakable tokens from the first block to the third block−the issuance volume of the secondary stakable tokens as of the first block)/the sum of each of the staked quantities of the primary stakable tokens of each of all the users as of the third block”+“(the cumulative issuance volume of the secondary stakable tokens from the first block to the fifth block−the cumulative issuance volume of the secondary stakable tokens from the first block to the third block)/the sum of each of the staked quantities of the primary stakable tokens of each of all the users as of the fifth block”.

Then, the staking management server 100 may update the previous first specific user stake-related index to the first specific user stake-related index by referring to the last value of the first stake-related partial index stored as a result of generating the token reward request transaction as the specific transaction

In other words, the staking management server 100 may update the previous first specific user stake-related index corresponding to the user C to the first specific user stake-related index at the seventh block after providing the reward to the user C.

In the above description, it was possible to determine both the current first total stake-related index and the previous first specific user stake-related index needed for determining the reward quantity of the secondary stakable tokens corresponding to the specific user. Now, based on this, the aforementioned redefined equation, which is possible to be used in common, may be expressed as “((the current first total stake-related index)−(the previous first specific user stake-related index))*(staked quantity of the primary stakable tokens of the specific user)”.

By referring to FIG. 6 again to apply the redefined equation, it is first assumed that the user C has requested for the reward at the seventh block. Then, the current first total stake-related index may be determined to be “the issuance volume of the secondary stakable tokens as of the first block/the sum of each of the staked quantities of the primary stakable tokens of each of all the users as of the first block”+“(the cumulative issuance volume of the secondary stakable tokens from the first block to the third block−the issuance volume of the secondary stakable tokens as of the first block)/the sum of each of the staked quantities of the primary stakable tokens of each of all the users as of the third block”+“(the cumulative issuance volume of the secondary stakable tokens from the first block to the fifth block−the cumulative issuance volume of the secondary stakable tokens from the first block to the third block)/the sum of each of the staked quantities of the primary stakable tokens of each of all the users as of the fifth block”+“(the cumulative issuance volume of the secondary stakable tokens from the first block to the seventh block−the cumulative issuance volume of the secondary stakable tokens from the first block to the fifth block)/the sum of each of the staked quantities of the primary stakable tokens of each of all the users as of the seventh block”.

In addition, the previous first specific user stake-related index at the seventh block may be determined to be “the issuance volume of the secondary stakable tokens as of the first block/the sum of each of the staked quantities of the primary stakable tokens of each of all the users as of the first block”+“(the cumulative issuance volume of the secondary stakable tokens from the first block to the third block−the issuance volume of the secondary stakable tokens as of the first block)/the sum of each of the staked quantities of the primary stakable tokens of each of all the users as of the third block”+“(the cumulative issuance volume of the secondary stakable tokens from the first block to the fifth block−the cumulative issuance volume of the secondary stakable tokens from the first block to the third block)/the sum of each of the staked quantities of the primary stakable tokens of each of all the users as of the fifth block”.

Therefore, “the current first total stake-related index−the previous first specific user stake-related index” may be determined to be “(the cumulative issuance volume of the secondary stakable tokens from the first block to the seventh block−the cumulative issuance volume of the secondary stakable tokens from the first block to the fifth block)/the sum of each of the staked quantities of the primary stakable tokens of each of all the users as of the seventh block”.

Next, it can be understood that the “staked quantity of the primary stakable tokens of the specific user” is 1 since this is the quantity of the primary stakable tokens staked by the user C.

Now, substituting the aforementioned values into the redefined equation, ((7−5)/3))*1=2/3=0.666666 . . . is obtained. In summary, in response to the user C requesting for the reward of the secondary stakable tokens at the seventh block, the user C is rewarded with 0.666666 . . . secondary stakable tokens by referring to the first reward basis value.

Herein, when the specific transaction, which is the token reward request transaction generated by the specific user, occurs at a same block as another transaction, which is any one of the token staking transaction and the token unstaking transaction generated by another user, the staking management server 100 may perform the specific transaction first and then perform the another transaction afterwards. In other words, when the user C generates the token reward request transaction at the seventh block and a user D (not shown) generates the token staking transaction at the seventh block, staking information of the user D is not taken into account while the reward for the user c is being processed, and staking made by the user D is processed after the reward for the user C is processed, but the present disclosure is not limited thereto.

FIG. 7 is a table schematically illustrating an example of computing each unit point for calculating additional payouts for each of the user A, the user B, and the user C as a result of the user A, the user B and the user C, each of whom is part of the total users participating in the specific staking pool, staking the primary stakable tokens in the specific staking pool in accordance with one embodiment of the present invention.

FIG. 6 explains a method of calculating basic reward shares for the users participating in the specific staking pool, while FIG. 7 further explains how each of the users performing staking may accumulate the unit points for calculating additional payouts to each user according to their respective staked periods, and how a user who has staked before the other users is given a benefit accordingly.

First, the staking management server 100 may accumulate a unit point for calculating additional payouts at each block according to each staked period of a 1-st user to a z-th user, generate a second reward basis value by referring to the unit point for calculating additional payouts (i.e., a cumulative unit point for calculating additional payouts, more specifically) and the first reward basis value, and determine a specific user secondary stakable token quantity corresponding to the specific user by referring to the second reward basis value. Herein, starting from an (L_2)-nd block succeeding an (L_1)-st block in which the specific user corresponding to any one of the 1-st user to the z-th user has begun staking the primary stakable tokens, the staking management server 100 may accumulate, as the unit point for calculating additional payouts at each block, a ratio of a cumulative number of blocks, corresponding to a staked period starting from the (L_2)-nd block, to a total number of blocks generated within a specific period of time in which the unit point for calculating additional payouts is accumulatively calculated, and assign the unit point for calculating additional payouts at each block to the specific user.

Herein, by referring to FIG. 7, bolded values included in blocks may correspond to the unit points for calculating additional payouts. That is, for the user A who has started staking at the first block, the unit point for calculating additional payouts is assigned from the second block which is the next block of the first block mentioned above. Likewise, for the user B who has started staking at the third block, the unit point for calculating additional payouts is assigned from the fourth block which is the next block of the third block mentioned above, and for the user C who has started staking at the fifth block, the unit point for calculating additional payouts is assigned from the sixth block which is the next block of the fifth block mentioned above.

Then, the staking management server 100 may determine, as a unit point for calculating additional payouts of the specific user, the unit point for calculating additional payouts accumulated for the specific user at an (L_i)-th block generated later than an (L_2)-nd block by a specific number of blocks, the (L_2)-nd block succeeding an (L_1)-st block in which the specific user corresponding to any one of the 1-st user to the z-th user has begun staking the primary stakable tokens, and then determine, as a unit point for calculating additional payouts of all the users, a sum of the unit point for calculating additional payouts accumulated for each of all the users at the (L_i)-th block. For example, the unit point for calculating additional payouts of the specific user corresponding to the user C at the seventh block may be determined to be “2/31,536,000”, and the unit point for calculating additional payouts of all the users at the seventh block may be determined to be “6/31,536,000+4/31,536,000+2/31,536,000”, that is, “12/31,536,000”.

Herein, 31,536,000 is a value obtained by converting 365 days into seconds (of course, variations such as converting 30 days, instead of 365 days, into seconds may be possible), and for example, since the user A is assigned with the unit point for calculating additional payouts starting from the second block, so assuming that a block is generated for every second, the unit point for calculating additional payouts for the user A at a 31,536,001-th block after 365 days will be 31,536,000/31,536,000=1.

Hereinafter, a process of calculating the second reward basis value by referring to the first reward basis value (0.666 . . . ) calculated earlier for the user C who requested the reward at the seventh block, the unit point for calculating additional payouts of all the users and the unit point for calculating additional payouts of the specific user is described.

First, in response to the token reward request transaction being generated at the (k_n)-th block, which serves as the specific block, the staking management server 100 may, for each of the (k_1)-st block to the (k_n)-th block, at which any of the token staking transaction, the token unstaking transaction and the token reward request transaction has occurred, among the first block to the p-th block generated up to the current point of time, set a (2_1)-st ratio to a (2_n)-th ratio of the cumulative issuance volume of the secondary stakable tokens to each of sums of each of total staked quantities of the primary stakable tokens corresponding to each of the (k_1)-st block to the (k_n)-th block and each unit point for calculating additional payouts of all the users corresponding to each of the (k_1)-st block to the (k_n)-th block, as a (2_1)-st stake-related partial index to a (2_n)-th stake-related partial index, and acquire a current second total stake-related index by summing up each of the (2_1)-st stake-related partial index to the (2_n)-th stake-related partial index.

In addition, as a result of generating any one of the token staking transaction, the token unstaking transaction and the token reward request transaction at the (k_m)-th block, which is a block previous to the (k_n)-th block, by the specific user who requested the token reward request transaction, the staking management server 100 may set, at each of the (k_1)-st block to the (k_m)-th block, a (3_1)-st ratio to a (3_m)-th ratio of the cumulative issuance volume of the secondary stakable tokens to each of sums of each of total staked quantities of the primary stakable tokens corresponding to each of the (k_1)-st block to the (k_m)-th block and each unit point for calculating additional payouts of all the users corresponding to each of the (k_1)-st block to the (k_m)-th block, as a (3_1)-st stake-related partial index to a (3_m)-th stake-related partial index, and acquire a second specific user stake-related index by summing up each of the (3_1)-st stake-related partial index to the (3_m)-th stake-related partial index.

In summary, by referring to FIG. 6, the current first total stake-related index at the seventh block and the previous first specific user stake-related index corresponding to the user C are determined, and thus the first reward basis value can be obtained from them.

Herein, the sum of each of staked quantities of the primary stakable tokens of each of all the users at each block, which was used as each denominator of the current first total stake-related index, and each unit point for calculating additional payouts of all the users assigned for each block may be added to be used as respective adjusted denominators.

In other words, each of ratios of (1) each cumulative issuance volume of the secondary stakable tokens, corresponding to each of the first block, the third block, the fifth block and the seventh block at which the specific transaction occurred in FIG. 7, to (2) each of sums of (i) each of the total staked quantities, used as each of the denominators for each of the first total stake-related indexes corresponding to each of the first block, the third block, the fifth block and the seventh block, and (ii) each of the unit points for calculating additional payouts of all the users, corresponding to each of the first block, the third block, the fifth block and the seventh block, may be determined as the (2_1)-st stake-related partial index to the (2_n)-th stake-related partial index. Herein, the (2_n)-th stake-related partial index represents the (2_4)-th stake-related partial index, in this case. Then, the current second total stake-related index may be determined by adding up the (2_1)-st stake-related partial index to the (2_n)-th stake-related partial index. Herein, the current second total stake-related index may be a result that reflects each unit point for calculating additional payouts assigned for each user.

Next, each of ratios of each cumulative issuance volume of the secondary stakable tokens, corresponding to each of the first block, the third block, and the fifth block at which the specific transaction occurred in FIG. 7, to each of sums of each of the total staked quantities, used as each of the denominators for each of the first total stake-related indexes corresponding to each of the first block, the third block, and the fifth block, and each of the unit points for calculating additional payouts of all the users, corresponding to each of the first block, the third block, and the fifth block, may be determined as the (3_1)-st stake-related partial index to the (3_m)-th stake-related partial index. Herein, the (3_m)-th stake-related partial index represents the (3_3)-rd stake-related partial index, in this case. Then, the second specific user stake-related index may be determined by adding up the (3_1)-st stake-related partial index to the (3_m)-th stake-related partial index. Herein, the second specific user stake-related index may be a result that reflects each unit point for calculating additional payouts assigned for each user.

Further, by referring back to FIG. 7, the user C is assigned with the unit point for calculating additional payouts at the sixth block and is assigned with the unit point for calculating additional payouts of 2/31,536,000 at the seventh block at which the reward is requested. In summary, at the seventh block in which the user C requested the reward, an adjusted staked quantity of the primary stakable tokens of the user C becomes a value obtained by adding an initial staked quantity of 1 and the unit point for calculating additional payouts of 2/31,536,000, accumulated as of the seventh block.

Thus, the current second total stake-related index, the second specific user stake-related index and the adjusted staked quantity of the primary stakable tokens of the specific user (the user C, in this case) to which each unit point for calculating additional payouts assigned for each user has been reflected are obtained. Now, by referring to the equation of calculating the reward quantity of the secondary stakable tokens that the user C will receive from the request for the reward in FIG. 6 again, “((the current second total stake-related index)−(the second specific user stake-related index))*(the adjusted staked quantity of the primary stakable tokens of the specific user)” may be obtained. Inserting detailed values into the respective factors of the above equation by referring to FIG. 7, a value of (1+2/31,536,000)*((7−5)/(3+12/31,536,000)) may be obtained, and by calculating this, the use C is rewarded with 0.666666624386949 secondary stakable tokens (i.e., the second reward basis value) at the seventh block.

Herein, in case a first reward-requesting user, among the 1-st user to the z-th user, has staked the primary stakable tokens by a certain number of blocks later than a second reward-requesting user among the 1-st user to the z-th user, the staking management server 100 may assign a penalty of a predetermined penalty condition to a first secondary stakable token quantity of the first reward-requesting user, and determine the second reward basis value by assigning a reward of a predetermined reward condition corresponding to the penalty to a second secondary stakable token quantity of the second reward-requesting user.

In summary, the quantity of rewarded tokens that do not reflect the unit point for calculating additional payouts is 0.666666 . . . in FIG. 6, while the quantity of rewarded tokens that do reflect the unit points for calculating additional payouts is 0.666666624386949 . . . in FIG. 7, which is slightly less than 0.66666 . . . . The reason why the quantity of the secondary stakable tokens that the user C receives as the reward is smaller is that the user C staked the primary stakable tokens relatively later than the other users (i.e., the user A and the user B) and was penalized accordingly, resulting in a slightly smaller quantity than the original quantity. The quantity of reward that the user C was not able to receive may be calculated as a reward(s) corresponding to the unit point for calculating additional payouts when the user A and the user B are claiming rewards, and as a result, the user A and the user B are eligible to receive additional rewards.

This means that since the user A started staking faster than anyone else, the number of the primary stakable tokens that the user A staked at first was 1, but after a year, the quantity of staking made by the user A is calculated to be 1+(31,536,000/31,536,000)=2, which will ultimately give rise to an effect of staking two primary stakable tokens.

The present disclosure has an effect of allowing users to concentrate on staking of the primary stakable tokens during an earlier period of time so that a quantity of the secondary stakable tokens provided as the reward tokens to the users for taking the primary stakable tokens increases according to a staking duration thereof, thereby reducing a waste of hardware required for mining tokens.

The present disclosure has another effect of preventing delays in computing stake-related indexes necessary for distributing the reward tokens according to the token reward request transaction and reducing a burden on the hardware required for computation thereof by updating a total stake-related index and a specific stake-related index of the specific user when the specific user generates a transaction.

The present disclosure has still another effect of determining the first reward basis value, generated by referring to the specific staked quantity of the primary stakable tokens corresponding to the specific user and the difference between the current first total stake-related index and the previous first specific user stake-related index of the specific user, as the specific user reward token quantity corresponding to the specific user.

The present disclosure has still yet another effect of accumulating the unit point for calculating additional payouts at each block according to each staked period of the 1-st user to the z-th user, generating the second reward basis value by referring to the unit point for calculating additional payouts and the first reward basis value, and determining the specific user secondary stakable token quantity corresponding to the specific user by referring to the second reward basis value.

Besides, the embodiments of the present disclosure as explained above can be implemented in a form of executable program command through a variety of computer means recordable to computer readable media. The computer readable media may store solely or in combination, program commands, data files, and data structures. The program commands recorded in the media may be components specially designed for the present disclosure or may be usable for a skilled human in a field of computer software. The computer readable media include, but are not limited to, magnetic media such as hard drives, floppy diskettes, magnetic tapes, memory cards, solid-state drives, USB flash drives, optical media such as CD-ROM and DVD, magneto-optical media such as floptical diskettes and hardware devices such as a read-only memory (ROM), a random access memory (RAM), and a flash memory specially designed to store and carry out program commands. Program commands may include not only a machine language code made by a compiler but also a high-level code that can be used by an interpreter etc., which is executed by a computer. The aforementioned hardware device may work as more than a software module to perform the action of the present disclosure and they may do the same in the opposite case. The hardware device may include a processor such as a CPU or a GPU, combined with a memory device such as ROM or RAM to store the program commands, configured to execute the commands stored in the memory, and a communication part which can exchange signals with external devices. In addition, the hardware device may include a keyboard, a mouse, and any other external input device to receive commands prepared by developers.

As seen above, the present disclosure has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for determining a payout rate of secondary stakable tokens by referring to staking information on primary stakable tokens of a specific user, comprising steps of:
(a) determining, by a staking management server, as a first stake-related partial index, a first ratio of a cumulative issuance volume of the secondary stakable tokens, acquired from an issuance volume of the secondary stakable tokens per block, to a total staked quantity of the primary stakable tokens acquired by summing up each of the staked quantities of the primary stakable tokens of each of all users who have staked the primary stakable tokens in a specific staking pool, wherein the first stake-related partial index has its corresponding value calculated and stored whenever a specific transaction, selected among a token staking transaction, a token unstaking transaction and a token reward request transaction, occurs by any user among all the users participating in the specific staking pool; and
(b) performing, by the staking management server, a process of determining a first specific user stake-related index by referring to a specific value of the first stake-related partial index, stored as a result of the specific transaction being generated by the specific user among all the users, and a process of updating a current first total stake-related index by referring to a last value of the first stake-related partial index, stored as a result of generating, as a most recent transaction, any one of the token staking transaction, the token unstaking transaction and the token reward request transaction,
wherein, at the step of (b), in response to the most recent transaction being determined as the token reward request transaction generated as the specific transaction by the specific user at a specific block, the staking management server (i) updates the current first total stake-related index by referring to the last value of the first stake-related partial index, stored as a result of generating the token reward request transaction as the most recent transaction, (ii) determines a first reward basis value as a specific user reward token quantity corresponding to the specific user, wherein the first reward basis value is generated by referring to a specific staked quantity of the primary stakable tokens corresponding to the specific user and a difference between the current first total stake-related index and a previous first specific user stake-related index of the specific user stored prior to updating to the first specific user stake-related index according to the last value of the first stake-related partial index stored as a result of generating the token reward request transaction as the specific transaction, and (iii) updates the previous first specific user stake-related index to the first specific user stake-related index by referring to the last value of the first stake-related partial index stored as a result of generating the token reward request transaction as the specific transaction.

2. The method of claim 1, wherein, at the step of (b), in response to the token reward request transaction being generated at a (k_n)-th block, which is the specific block, the staking management server (i) acquires the current first total stake-related index by summing up each value of the first stake-related partial index calculated from each of a (k_1)-st block to the (k_n)-th block at which any of the token staking transaction, the token unstaking transaction and the token reward request transaction has occurred, among a first block to a p-th block generated up to a current point of time, and (ii) acquires the previous first specific user stake-related index by summing each value of the first stake-related partial index calculated from each of the (k_1)-st block to a (k_m)-th block as a result of generating any one of the token staking transaction, the token unstaking transaction and the token reward request transaction at the (k_m)-th block, which is a block previous to the (k_n)-th block, by the specific user who requested the token reward request transaction.

3. The method of claim 1, wherein, at the step of (b), the staking management server accumulates a unit point for calculating additional payouts at each block according to each staked period of a 1-st user to a z-th user, generates a second reward basis value by referring to the unit point for calculating additional payouts and the first reward basis value, and determines a specific user secondary stakable token quantity corresponding to the specific user by referring to the second reward basis value,
wherein, in response to a first reward-requesting user, among the 1-st user to the z-th user, having staked the primary stakable tokens by a certain number of blocks later than a second reward-requesting user, the staking management server assigns a penalty of a predetermined penalty condition to a first secondary stakable token quantity of the first reward-requesting user, and determines the second reward basis value by assigning a reward of a predetermined reward condition corresponding to the penalty to a second secondary stakable token quantity of the second reward-requesting user.

4. The method of claim 3, wherein, starting from an (L_2)-nd block succeeding an (L_1)-st block in which the specific user corresponding to any one of the 1-st user to the z-th user has begun staking the primary stakable tokens, the staking management server accumulates, as the unit point for calculating additional payouts at each block, a ratio of a cumulative number of blocks, corresponding to a staked period starting from the (L_2)-nd block, to a total number of blocks generated within a specific period of time in which the unit point for calculating additional payouts is accumulatively calculated.

5. The method of claim 3, wherein the staking management server (i) determines, as a unit point for calculating additional payouts of the specific user, the unit point for calculating additional payouts accumulated for the specific user at an (L_i)-th block generated by a specific number of blocks later than an (L_2)-nd block, succeeding an (L_1)-st block in which the specific user corresponding to any one of the 1-st user to the z-th user has begun staking the primary stakable tokens, and (ii) determines, as a unit point for calculating additional payouts of all the users, a sum of the unit point for calculating additional payouts accumulated for each of all the users at the (L_i)-th block, and
wherein, in response to the token reward request transaction being generated at a (k_n)-th block, which is the specific block, the staking management server (i) (i−1) for each of a (k_1)-st block to the (k_n)-th block, at which any of the token staking transaction, the token unstaking transaction and the token reward request transaction has occurred, among a first block to a p-th block generated up to a current point of time, sets a (2_1)-st ratio to a (2_n)-th ratio of the cumulative issuance volume of the secondary stakable tokens to each of sums of each of total staked quantities of the primary stakable tokens corresponding to each of the (k_1)-st block to the (k_n)-th block and each unit point for calculating additional payouts of all the users corresponding to each of the (k_1)-st block to the (k_n)-th block, as a (2_1)-st stake-related partial index to a (2_n)-th stake-related partial index, and acquires a current second total stake-related index by summing up each of the (2_1)-st stake-related partial index to the (2_n)-th stake-related partial index, and (i−2) as a result of generating any one of the token staking transaction, the token unstaking transaction and the token reward request transaction at a (k_m)-th block, which is a block previous to the (k_n)-th block, by the specific user who requested the token reward request transaction, sets, at each of the (k_1)-st block to the (k_m)-th block, a (3_1)-st ratio to a (3_m)-th ratio of the cumulative issuance volume of the secondary stakable tokens to each of sums of each of total staked quantities of the primary stakable tokens corresponding to each of the (k_1)-st block to the (k_m)-th block and each unit point for calculating additional payouts of all the users corresponding to each of the (k_1)-st block to the (k_m)-th block, as a (3_1)-st stake-related partial index to a (3_m)-th stake-related partial index, and acquires a second specific user stake-related index by summing up each of the (3_1)-st stake-related partial index to the (3_m)-th stake-related partial index, and (ii) generates the second reward basis value by referring to the specific staked quantity of the primary stakable tokens corresponding to the specific user, the unit point for calculating additional payouts of the specific user, and a difference between the current second total stake-related index and the second specific user stake-related index, and determines specific user secondary stakable token quantity corresponding to the specific user by referring to the second reward basis value.

6. The method of claim 1, wherein, at the step of (b), when the specific transaction, which is the token reward request transaction generated by the specific user, occurs at a same block as another transaction, which is any one of the token staking transaction and the token unstaking transaction generated by another user, the specific transaction is performed first and then the another transaction is performed afterwards.

7. The method of claim 1, wherein, before the step of (a), the method further comprises steps of:
(a01) on condition that (1) the staking management server has transmitted a specific user wallet address to a specific user terminal in response to a staking request for a-th primary stakable tokens, which correspond to one type of the primary stakable tokens, from the specific user terminal, (2) a content providing server has transmitted first use permission request transaction information to be used for requesting permission to use the a-th primary stakable tokens to the staking management server and then the staking management server has transmitted first hashed use permission request transaction information, generated by hashing the first use permission request transaction information, to the content providing server, (3) the content providing server has transmitted first staking request transaction information to the staking management server and then the staking management server has transmitted first hashed staking request transaction information, generated by hashing the first staking request transaction information, to the content providing server, and (4) the content providing server has transmitted the first hashed use permission request transaction information and the first hashed staking request transaction information to the specific user terminal, the staking management server (i) receiving a signing request on the first hashed use permission request transaction information and the first hashed staking request transaction information from the specific user terminal, (ii) generating a first specific user signature value by signing the first hashed use permission request transaction information and the first hashed staking request transaction information with a specific user key, and (iii) transmitting the first specific user signature value to the specific user terminal;
(a02) (i) on condition that (1) the specific user terminal has transmitted the first hashed use permission request transaction information, the first hashed staking request transaction information and the first specific user signature value to the content providing server, and (2) the content providing server has transmitted second use permission request transaction information, including the first hashed use permission request transaction information and the first specific user signature value, to the staking management server, the staking management server invoking a token management contract to execute a token use permission request function whose parameters include a token staking contract address and a staked quantity of the a-th primary stakable tokens, to thereby receive a-th primary stakable token use permission request processing information and transmit the a-th primary stakable token use permission request processing information to the content providing server; (ii) on condition that the content providing server has transmitted second staking request transaction information, including the first hashed staking request transaction information and the first specific user signature value, to the staking management server, the staking management server invoking a token staking contract to execute a token staking request function whose parameters include the staked quantity of the a-th primary stakable tokens, to thereby receive a-th primary stakable token staking processing information, transmit the a-th primary stakable token staking processing information to the content providing server, and instruct the content providing server to transmit the a-th primary stakable token staking processing information to the specific user terminal.

8. The method of claim 7, wherein, at the step of (a01), on condition that the specific user terminal has logged into an electronic wallet application interworking with the staking management server and transmitted a staking request for the primary stakable tokens to the staking management server, the staking management server acquires the specific user wallet address corresponding to the specific user via the electronic wallet application and transmits the specific user wallet address along with information on the token management contract address, the token staking contract address, a name of the token use permission request function and a name of the token staking request function to the specific user terminal.

9. The method of claim 7, wherein the method further comprises steps of:
(a03) on condition that (1) the staking management server has transmitted the specific user wallet address to the specific user terminal in response to a staking request for b-th primary stakable tokens, which correspond to one type of the primary stakable tokens, from the specific user terminal, (2) the content providing server has transmitted third use permission request transaction information to be used for requesting permission to use the b-th primary stakable tokens to the staking management server and then the staking management server has transmitted third hashed use permission request transaction information, generated by hashing the third use permission request transaction information, to the content providing server, (3) the content providing server has transmitted third staking request transaction information to the staking management server and then the staking management server has transmitted third hashed staking request transaction information, generated by hashing the third staking request transaction information, to the content providing server, and (4) the content providing server has transmitted the third hashed use permission request transaction information and the third hashed staking request transaction information to the specific user terminal, the staking management server (i) receiving a signing request on the third hashed use permission request transaction information and the third hashed staking request transaction information from the specific user terminal, (ii) generating a second specific user signature value by signing the third hashed use permission request transaction information and the third hashed staking request transaction information with the specific user key, and (iii) transmitting the second specific user signature value to the specific user terminal;
(a04) (i) on condition that (1) the specific user terminal has transmitted the third hashed use permission request transaction information, the third hashed staking request transaction information and the second specific user signature value to the content providing server, and (2) the content providing server has transmitted fourth use permission request transaction information, including the third hashed use permission request transaction information and the second specific user signature value, to the staking management server, the staking management server invoking the token management contract to execute the token use permission request function whose parameters include the token staking contract address and a staked quantity of the b-th primary stakable tokens, to thereby receive b-th primary stakable token use permission request processing information and transmit the b-th primary stakable token use permission request processing information to the content providing server; (ii) on condition that the content providing server has transmitted fourth staking request transaction information, including the third hashed staking request transaction information and the second specific user signature value, to the staking management server, the staking management server invoking the token staking contract to execute the token staking request function whose parameters include the staked quantity of the b-th primary stakable tokens, to thereby receive b-th primary stakable token staking processing information, transmit the b-th primary stakable token staking processing information to the content providing server, and instruct the content providing server to transmit the b-th primary stakable token staking processing information to the specific user terminal;
wherein the steps of (a03) and (a04) are performed independently from the steps of (a01) and (a02), and each payout ratio of the secondary stakable tokens to each of the a-th primary stakable tokens and the b-th primary stakable tokens is determined according to predetermined conditions.

10. The method of claim 9, wherein the method further comprises steps of:
(c) on condition that (1) the staking management server has transmitted the specific user wallet address to the specific user terminal in response to a token reward request for the primary stakable tokens, among at least one type of the a-th primary stakable tokens and the b-th primary stakable tokens, (2) the content providing server has transmitted first reward request transaction information to be used for requesting rewards for the primary stakable tokens, among at least one type of the a-the primary stakable tokens and the b-th primary stakable tokens, to the staking management server and then the staking management server has transmitted first hashed reward request transaction information, generated by hashing the first reward request transaction information, to the content providing server, (3) the content providing server has transmitted the first hashed reward request transaction information to the specific user terminal, the staking management server (i) receiving a signing request on the first hashed reward request transaction information from the specific user terminal, (ii) generating a third specific user signature value by signing the first hashed reward request transaction information with the specific user key, and (iii) transmitting the third specific user signature value to the specific user terminal;
(d) on condition that (1) the specific user terminal has transmitted the first hashed reward request transaction information and the third specific user signature value to the content providing server, and (2) the content providing server has transmitted second reward request transaction information, including the first hashed reward request transaction information and the third specific user signature value, to the staking management server, the staking management server invoking a token reward contract to execute a token reward request function whose parameters include a token reward contract address, to thereby receive token reward processing information on the primary stakable tokens, among at least one type of the a-the primary stakable tokens and the b-th primary stakable tokens, and transmit the token reward processing information to the content providing server, and instruct the content providing server to transmit the token reward processing information to the specific user terminal.

11. A staking management server for determining a payout rate of secondary stakable tokens by referring to staking information on primary stakable tokens of a specific user, comprising:
at least one memory that stores instructions; and
at least one processor configured to execute the instructions to perform or support another device to perform: (I) a process of determining, as a first stake-related partial index, a first ratio of a cumulative issuance volume of the secondary stakable tokens, acquired from an issuance volume of the secondary stakable tokens per block, to a total staked quantity of the primary stakable tokens acquired by summing up each of the staked quantities of the primary stakable tokens of each of all users who have staked the primary stakable tokens in a specific staking pool, wherein the first stake-related partial index has its corresponding value calculated and stored whenever a specific transaction, selected among a token staking transaction, a token unstaking transaction and a token reward request transaction, occurs by any user among all the users participating in the specific staking pool, and (II) a process of determining a first specific user stake-related index by referring to a specific value of the first stake-related partial index, stored as a result of the specific transaction being generated by the specific user among all the users, and a process of updating a current first total stake-related index by referring to a last value of the first stake-related partial index, stored as a result of generating, as a most recent transaction, any one of the token staking transaction, the token unstaking transaction and the token reward request transaction, wherein, at the process of (II), in response to the most recent transaction being determined as the token reward request transaction generated as the specific transaction by the specific user at a specific block, the processor (i) updates the current first total stake-related index by referring to the last value of the first stake-related partial index, stored as a result of generating the token reward request transaction as the most recent transaction, (ii) determines a first reward basis value as a specific user reward token quantity corresponding to the specific user, wherein the first reward basis value is generated by referring to a specific staked quantity of the primary stakable tokens corresponding to the specific user and a difference between the current first total stake-related index and a previous first specific user stake-related index of the specific user stored prior to updating to the first specific user stake-related index according to the last value of the first stake-related partial index stored as a result of generating the token reward request transaction as the specific transaction, and (iii) updates the previous first specific user stake-related index to the first specific user stake-related index by referring to the last value of the first stake-related partial index stored as a result of generating the token reward request transaction as the specific transaction.

12. The staking management server of claim 11, wherein, at the process of (II), in response to the token reward request transaction being generated at a (k_n)-th block, which is the specific block, the processor (i) acquires the current first total stake-related index by summing up each value of the first stake-related partial index calculated from each of a (k_1)-st block to the (k_n)-th block at which any of the token staking transaction, the token unstaking transaction and the token reward request transaction has occurred, among a first block to a p-th block generated up to a current point of time, and (ii) acquires the previous first specific user stake-related index by summing each value of the first stake-related partial index calculated from each of the (k_1)-st block to a (k_m)-th block as a result of generating any one of the token staking transaction, the token unstaking transaction and the token reward request transaction at the (k_m)-th block, which is a block previous to the (k_n)-th block, by the specific user who requested the token reward request transaction.

13. The staking management server of claim 11, wherein, at the process of (II), the processor accumulates a unit point for calculating additional payouts at each block according to each staked period of a 1-st user to a z-th user, generates a second reward basis value by referring to the unit point for calculating additional payouts and the first reward basis value, and determines a specific user secondary stakable token quantity corresponding to the specific user by referring to the second reward basis value,
wherein, in response to a first reward-requesting user, among the 1-st user to the z-th user, having staked the primary stakable tokens by a certain number of blocks later than a second reward-requesting user, the processor assigns a penalty of a predetermined penalty condition to a first secondary stakable token quantity of the first reward-requesting user, and determines the second reward basis value by assigning a reward of a predetermined reward condition corresponding to the penalty to a second secondary stakable token quantity of the second reward-requesting user.

14. The staking management server of claim 13, wherein, starting from an (L_2)-nd block succeeding an (L_1)-st block in which the specific user corresponding to any one of the 1-st user to the z-th user has begun staking the primary stakable tokens, the processor accumulates, as the unit point for calculating additional payouts at each block, a ratio of a cumulative number of blocks, corresponding to a staked period starting from the (L_2)-nd block, to a total number of blocks generated within a specific period of time in which the unit point for calculating additional payouts is accumulatively calculated.

15. The staking management server of claim 13, wherein the processor (i) determines, as a unit point for calculating additional payouts of the specific user, the unit point for calculating additional payouts accumulated for the specific user at an (L_i)-th block generated by a specific number of blocks later than an (L_2)-nd block, succeeding an (L_1)-st block in which the specific user corresponding to any one of the 1-st user to the z-th user has begun staking the primary stakable tokens, and (ii) determines, as a unit point for calculating additional payouts of all the users, a sum of the unit point for calculating additional payouts accumulated for each of all the users at the (L_i)-th block, and
wherein, in response to the token reward request transaction being generated at a (k_n)-th block, which is the specific block, the processor (i) (i−1) for each of a (k_1)-st block to the (k_n)-th block, at which any of the token staking transaction, the token unstaking transaction and the token reward request transaction has occurred, among a first block to a p-th block generated up to a current point of time, sets a (2_1)-st ratio to a (2_n)-th ratio of the cumulative issuance volume of the secondary stakable tokens to each of sums of each of total staked quantities of the primary stakable tokens corresponding to each of the (k_1)-st block to the (k_n)-th block and each unit point for calculating additional payouts of all the users corresponding to each of the (k_1)-st block to the (k_n)-th block, as a (2_1)-st stake-related partial index to a (2_n)-th stake-related partial index, and acquires a current second total stake-related index by summing up each of the (2_1)-st stake-related partial index to the (2_n)-th stake-related partial index, and (i−2) as a result of generating any one of the token staking transaction, the token unstaking transaction and the token reward request transaction at a (k_m)-th block, which is a block previous to the (k_n)-th block, by the specific user who requested the token reward request transaction, sets, at each of the (k_1)-st block to the (k_m)-th block, a (3_1)-st ratio to a (3_m)-th ratio of the cumulative issuance volume of the secondary stakable tokens to each of sums of each of total staked quantities of the primary stakable tokens corresponding to each of the (k_1)-st block to the (k_m)-th block and each unit point for calculating additional payouts of all the users corresponding to each of the (k_1)-st block to the (k_m)-th block, as a (3_1)-st stake-related partial index to a (3_m)-th stake-related partial index, and acquires a second specific user stake-related index by summing up each of the (3_1)-st stake-related partial index to the (3_m)-th stake-related partial index, and (ii) generates the second reward basis value by referring to the specific staked quantity of the primary stakable tokens corresponding to the specific user, the unit point for calculating additional payouts of the specific user, and a difference between the current second total stake-related index and the second specific user stake-related index, and determines specific user secondary stakable token quantity corresponding to the specific user by referring to the second reward basis value.

16. The staking management server of claim 11, wherein, at the process of (II), when the specific transaction, which is the token reward request transaction generated by the specific user, occurs at a same block as another transaction, which is any one of the token staking transaction and the token unstaking transaction generated by another user, the specific transaction is performed first and then the another transaction is performed afterwards.

17. The staking management server of claim 11, wherein, before the process of (I), the processor further performs processes of:
(I01) on condition that (1) the processor has transmitted a specific user wallet address to a specific user terminal in response to a staking request for a-th primary stakable tokens, which correspond to one type of the primary stakable tokens, from the specific user terminal, (2) a content providing server has transmitted first use permission request transaction information to be used for requesting permission to use the a-th primary stakable tokens to the processor and then the processor has transmitted first hashed use permission request transaction information, generated by hashing the first use permission request transaction information, to the content providing server, (3) the content providing server has transmitted first staking request transaction information to the processor and then the processor has transmitted first hashed staking request transaction information, generated by hashing the first staking request transaction information, to the content providing server, and (4) the content providing server has transmitted the first hashed use permission request transaction information and the first hashed staking request transaction information to the specific user terminal, the processor (i) receiving a signing request on the first hashed use permission request transaction information and the first hashed staking request transaction information from the specific user terminal, (ii) generating a first specific user signature value by signing the first hashed use permission request transaction information and the first hashed staking request transaction information with a specific user key, and (iii) transmitting the first specific user signature value to the specific user terminal;
(I02) (i) on condition that (1) the specific user terminal has transmitted the first hashed use permission request transaction information, the first hashed staking request transaction information and the first specific user signature value to the content providing server, and (2) the content providing server has transmitted second use permission request transaction information, including the first hashed use permission request transaction information and the first specific user signature value, to the processor, the processor invoking a token management contract to execute a token use permission request function whose parameters include a token staking contract address and a staked quantity of the a-th primary stakable tokens, to thereby receive a-th primary stakable token use permission request processing information and transmit the a-th primary stakable token use permission request processing information to the content providing server; (ii) on condition that the content providing server has transmitted second staking request transaction information, including the first hashed staking request transaction information and the first specific user signature value, to the processor, the processor invoking a token staking contract to execute a token staking request function whose parameters include the staked quantity of the a-th primary stakable tokens, to thereby receive a-th primary stakable token staking processing information, transmit the a-th primary stakable token staking processing information to the content providing server, and instruct the content providing server to transmit the a-th primary stakable token staking processing information to the specific user terminal.

18. The staking management server of claim 17, wherein, at the process of (I01), on condition that the specific user terminal has logged into an electronic wallet application interworking with the processor and transmitted a staking request for the primary stakable tokens to the processor, the processor acquires the specific user wallet address corresponding to the specific user via the electronic wallet application and transmits the specific user wallet address along with information on the token management contract address, the token staking contract address, a name of the token use permission request function and a name of the token staking request function to the specific user terminal.

19. The staking management server of claim 17, wherein the processor further performs processes of:
(I03) on condition that (1) the processor has transmitted the specific user wallet address to the specific user terminal in response to a staking request for b-th primary stakable tokens, which correspond to one type of the primary stakable tokens, from the specific user terminal, (2) the content providing server has transmitted third use permission request transaction information to be used for requesting permission to use the b-th primary stakable tokens to the processor and then the processor has transmitted third hashed use permission request transaction information, generated by hashing the third use permission request transaction information, to the content providing server, (3) the content providing server has transmitted third staking request transaction information to the processor and then the processor has transmitted third hashed staking request transaction information, generated by hashing the third staking request transaction information, to the content providing server, and (4) the content providing server has transmitted the third hashed use permission request transaction information and the third hashed staking request transaction information to the specific user terminal, the processor (i) receiving a signing request on the third hashed use permission request transaction information and the third hashed staking request transaction information from the specific user terminal, (ii) generating a second specific user signature value by signing the third hashed use permission request transaction information and the third hashed staking request transaction information with the specific user key, and (iii) transmitting the second specific user signature value to the specific user terminal;
(I04) (i) on condition that (1) the specific user terminal has transmitted the third hashed use permission request transaction information, the third hashed staking request transaction information and the second specific user signature value to the content providing server, and (2) the content providing server has transmitted fourth use permission request transaction information, including the third hashed use permission request transaction information and the second specific user signature value, to the processor, the processor invoking the token management contract to execute the token use permission request function whose parameters include the token staking contract address and a staked quantity of the b-th primary stakable tokens, to thereby receive b-th primary stakable token use permission request processing information and transmit the b-th primary stakable token use permission request processing information to the content providing server; (ii) on condition that the content providing server has transmitted fourth staking request transaction information, including the third hashed staking request transaction information and the second specific user signature value, to the processor, the processor invoking the token staking contract to execute the token staking request function whose parameters include the staked quantity of the b-th primary stakable tokens, to thereby receive b-th primary stakable token staking processing information, transmit the b-th primary stakable token staking processing information to the content providing server, and instruct the content providing server to transmit the b-th primary stakable token staking processing information to the specific user terminal;
wherein the processes of (I03) and (I04) are performed independently from the processes of (I01) and (I02), and each payout ratio of the secondary stakable tokens to each of the a-th primary stakable tokens and the b-th primary stakable tokens is determined according to predetermined conditions.

20. The staking management server of claim 19, wherein the processor further performs processes of:
(III) on condition that (1) the processor has transmitted the specific user wallet address to the specific user terminal in response to a token reward request for the primary stakable tokens, among at least one type of the a-th primary stakable tokens and the b-th primary stakable tokens, (2) the content providing server has transmitted first reward request transaction information to be used for requesting rewards for the primary stakable tokens, among at least one type of the a-the primary stakable tokens and the b-th primary stakable tokens, to the processor and then the processor has transmitted first hashed reward request transaction information, generated by hashing the first reward request transaction information, to the content providing server, (3) the content providing server has transmitted the first hashed reward request transaction information to the specific user terminal, the processor (i) receiving a signing request on the first hashed reward request transaction information from the specific user terminal, (ii) generating a third specific user signature value by signing the first hashed reward request transaction information with the specific user key, and (iii) transmitting the third specific user signature value to the specific user terminal;
(IV) on condition that (1) the specific user terminal has transmitted the first hashed reward request transaction information and the third specific user signature value to the content providing server, and (2) the content providing server has transmitted second reward request transaction information, including the first hashed reward request transaction information and the third specific user signature value, to the processor, the processor invoking a token reward contract to execute a token reward request function whose parameters include a token reward contract address, to thereby receive token reward processing information on the primary stakable tokens, among at least one type of the a-the primary stakable tokens and the b-th primary stakable tokens, and transmit the token reward processing information to the content providing server, and instruct the content providing server to transmit the token reward processing information to the specific user terminal.
